(19) United States
(12) Patent Application Publication
(10) Pub. No.: US 2025/0102886 A1
(43) Pub. Date: Mar. 27, 2025

(54) FINDER OPTICAL SYSTEM, FINDER DEVICE, AND IMAGING APPARATUS

(71) Applicant: FUJIFILM Corporation, Tokyo (JP)

(72) Inventors: Taku FURUBAYASHI, Saitama-shi (JP); Yu KITAHARA, Saitama-shi (JP)

(73) Assignee: FUJIFILM Corporation, Tokyo (JP)

(21) Appl. No.: 18/972,741

(22) Filed: Dec. 6, 2024

Related U.S. Application Data
(63) Continuation of application No. PCT/JP2023/018471, filed on May 17, 2023.

(30) Foreign Application Priority Data
Jun. 15, 2022 (JP) 2022-096655

(51) Int. Cl. G03B 13/06; G02B 5/18; G02B 9/34; G02B 9/60

(52) U.S. Cl. CPC G03B 13/06; G02B 5/1866; G02B 9/34; G02B 9/60; G03B 2213/02

(57) ABSTRACT

A finder optical system includes a display element, and an ocular optical system disposed on an eyepoint side with respect to the display element. One or more diffraction elements are disposed in the finder optical system. At least one of the diffraction elements is a first diffraction element including a liquid crystal diffraction element. In a case where a distance on an optical axis from a display surface of the display element to a surface of the finder optical system closest to the eyepoint side is denoted by TL, and a distance on the optical axis from the display surface of the display element to an optical surface of the first diffraction element is denoted by X1, the finder optical system satisfies a conditional expression represented by 0.05≤X1/TL≤1.

### CROSS-REFERENCE TO RELATED APPLICATIONS

This application is a continuation application of International Application No. PCT/JP2023/018471, filed on May 17, 2023, which claims priority from Japanese Patent Application No. 2022-096655, filed on Jun. 15, 2022. The entire disclosure of each of the above applications is incorporated herein by reference.

### BACKGROUND

### Technical Field

The present disclosure relates to a finder optical system, a finder device, and an imaging apparatus.

### Related Art

In the related art, optical systems according to JP2020-154190A and JP2019-144550A have been known as an observation optical system or a finder optical system. JP2020-154190A describes an observation optical system including a lens having a diffractive optical surface. JP2019-144550A discloses a finder optical system including a diffractive optical element.

In recent years, there has been a demand for a finder optical system that is reduced in size and enables favorable observation. However, the diffractive optical surface according to JP2020-154190A is a diffractive optical surface having a physical shape of a level difference (hereinafter, referred to as a relief diffractive optical surface) and is in contact with air. Thus, light scattered by the level difference may cause flare, which reduces resolution. The diffractive optical element according to JP2019-144550A has a so-called closely attached multilayer configuration in which two layers of diffractive optical surfaces having a relief diffractive optical surface are closely attached to each other. While the closely attached multilayer diffractive optical element can reduce occurrence of flare compared to a configuration in which the diffractive optical surface is in contact with air, the closely attached multilayer diffractive optical element requires a high level of technology, which may increase a cost.

### SUMMARY

An object of the present disclosure is to provide a finder optical system, a finder device, and an imaging apparatus that are reduced in size and enable favorable observation without increasing a cost.

According to an aspect of the present disclosure, there is provided a finder optical system comprising a display element, and an ocular optical system disposed on an eyepoint side with respect to the display element, in which one or more diffraction elements are disposed in the finder optical system, at least one of the diffraction elements is a first diffraction element including a liquid crystal diffraction element, and in a case where a distance on an optical axis from a display surface of the display element to a surface of the finder optical system closest to the eyepoint side is denoted by TL, and a distance on the optical axis from the display surface to an optical surface of the first diffraction element is denoted by X1, Conditional Expression (1) is satisfied, which is represented by

0.05≤X1/TL≤1 (1).

In a case where a half value of a longest diameter of a display region in the display element is denoted by H, and a focal length of the finder optical system is denoted by f, the finder optical system preferably satisfies Conditional Expression (2) represented by

0.3<H/f<0.7 (2).

In a case where a distance on the optical axis from the surface of the finder optical system closest to the eyepoint side to an eyepoint is denoted by dEP, and a focal length of the finder optical system is denoted by f, the finder optical system preferably satisfies Conditional Expression (3) represented by

0<f/dEP<0.95 (3).

The ocular optical system preferably includes two or more positive lenses and one or more negative lenses.

The ocular optical system preferably includes two or more aspherical lenses and one or more spherical lenses.

The diffraction element is preferably provided on a surface of an optical element, and an Abbe number based on a d line for the optical element is preferably greater than or equal to 35.

The diffraction element is preferably provided on a surface of an optical element, and transmittance on a d line for the optical element is preferably greater than or equal to 98%.

In a case where a distance on the optical axis from the display surface to an optical element in the finder optical system is denoted by X, transmittance on a d line for a partial optical system consisting of all optical elements disposed within a range of 0.05≤X/TL≤1 is preferably greater than or equal to 92%.

The diffraction element may be configured to be provided on a surface of an optical element, and lenses having a refractive power may be configured to be disposed on both of an object side and an image side of the optical element.

The diffraction element is preferably provided on a surface of an optical element, a lens having a refractive power is preferably disposed adjacent to the optical element on at least one of an object side or an image side of the optical element, and a minimum spacing in an optical axis direction between an optical surface of the diffraction element provided on the surface of the optical element and an optical surface of the lens is preferably less than or equal to 1.8 mm.

A thickness, in an optical axis direction, of a region having a diffraction action of the diffraction element is preferably less than or equal to 10 μm.

At least one of the diffraction elements preferably is a second diffraction element including a liquid crystal diffraction element, an element having a refractive power is preferably not disposed between the display surface and the second diffraction element, and in a case where a distance on the optical axis from the display surface to an optical surface of the second diffraction element is denoted by X2, Conditional Expression (4) is preferably satisfied, which is represented by

0≤X2/TL<0.05 (4).

In this case, a sign of a phase difference function of the first diffraction element is preferably different from a sign of a phase difference function of the second diffraction element.

The diffraction element preferably has a periodic structure in a direction perpendicular to the optical axis and has a concentric structure centered on the optical axis. In this case, a period of the periodic structure is preferably gradually decreased from the optical axis to an edge part. A period of the periodic structure in a most edge part of the diffraction element is preferably greater than or equal to 0.5 μm.

The number of lenses having a refractive power included in the finder optical system may be configured to be four or five.

According to another aspect of the present disclosure, there is provided a finder device comprising the finder optical system of the above aspect, in which output light from the display element is polarized light.

According to still another aspect of the present disclosure, there is provided an imaging apparatus comprising the finder optical system of the above aspect, in which output light from the display element is polarized light.

In the present specification, the term “lens having a positive refractive power” is synonymous with the term “positive lens”. The term “lens having a negative refractive power” is synonymous with the term “negative lens”. The term “single lens” means one non-cemented lens. A compound aspherical lens (a lens that is composed of a spherical lens and a film of an aspherical shape formed on the spherical lens in an integrated manner and that functions as one aspherical lens as a whole) is not regarded as a cemented lens and is treated as one lens. Unless otherwise specified, a sign of a refractive power related to a lens including an aspherical surface in a paraxial region is used.

The term “focal length” used in the conditional expressions is a paraxial focal length. The values used in the conditional expressions are values based on the d line. Unless otherwise specified, the term “distance on the optical axis” used in the conditional expressions is a geometrical distance on the optical axis. In a system capable of performing diopter adjustment, the values used in the conditional expressions are values in a state of −1 diopter. The terms “d line”, “C line”, and “F line” according to the present specification are bright lines. A wavelength of the d line is 587.56 nm. A wavelength of the C line is 656.27 nm. A wavelength of the F line is 486.13 nm. In the present specification, “mm” means millimeters, “nm” means nanometers, and “m” means micrometers.

According to the present disclosure, a finder optical system, a finder device, and an imaging apparatus that are reduced in size and enable favorable observation without increasing a cost can be provided.

### BRIEF DESCRIPTION OF THE DRAWINGS

FIG. 1 is a cross-sectional view corresponding to a finder optical system of Example 1 and illustrating a configuration and luminous fluxes of a finder optical system according to one embodiment.

FIG. 2 is each aberration diagram of the finder optical system of Example 1.

FIG. 3 is a cross-sectional view illustrating a configuration and luminous fluxes of a finder optical system of Example 2.

FIG. 4 is each aberration diagram of the finder optical system of Example 2.

FIG. 5 is a cross-sectional view illustrating a configuration and luminous fluxes of a finder optical system of Example 3.

FIG. 6 is each aberration diagram of the finder optical system of Example 3.

FIG. 7 is a cross-sectional view illustrating a configuration and luminous fluxes of a finder optical system of Example 4.

FIG. 8 is each aberration diagram of the finder optical system of Example 4.

FIG. 9 is a cross-sectional view illustrating a configuration and luminous fluxes of a finder optical system of Example 5.

FIG. 10 is each aberration diagram of the finder optical system of Example 5.

FIG. 11 is a cross-sectional view illustrating a configuration and luminous fluxes of a finder optical system of Example 6.

FIG. 12 is each aberration diagram of the finder optical system of Example 6.

FIG. 13 is a cross-sectional view illustrating a configuration and luminous fluxes of a finder optical system of Example 7.

FIG. 14 is each aberration diagram of the finder optical system of Example 7.

FIG. 15 is a cross-sectional view illustrating a configuration and luminous fluxes of a finder optical system of Example 8.

FIG. 16 is each aberration diagram of the finder optical system of Example 8.

FIG. 17 is a diagram schematically illustrating a configuration of an example of a liquid crystal diffraction element.

FIG. 18 is a schematic plan view illustrating an optically anisotropic layer of the liquid crystal diffraction element illustrated in FIG. 17.

FIG. 19 is a conceptual diagram illustrating an action of the optically anisotropic layer of the liquid crystal diffraction element illustrated in FIG. 17.

FIG. 20 is a conceptual diagram illustrating an action of the optically anisotropic layer of the liquid crystal diffraction element illustrated in FIG. 17.

FIG. 21 is a schematic configuration diagram of an example of an exposure device that exposes an alignment film.

FIG. 22 is a diagram schematically illustrating a configuration of another example of the liquid crystal diffraction element.

FIG. 23 is a conceptual diagram illustrating an action of the optically anisotropic layer of the liquid crystal diffraction element illustrated in FIG. 22.

FIG. 24 is a schematic plan view illustrating a liquid crystal diffraction element according to one embodiment.

FIG. 25 is a schematic configuration diagram of a finder device and an imaging apparatus according to one embodiment.

### DETAILED DESCRIPTION

Hereinafter, an embodiment of the present disclosure will be described with reference to the drawings.

In the present specification, a numerical range represented by “to” means a range including numerical values before and after “to” as a lower limit value and an upper limit value. In the present specification, the terms “orthogonal” and “parallel” in terms of angles include an error range generally allowed in the technical field.

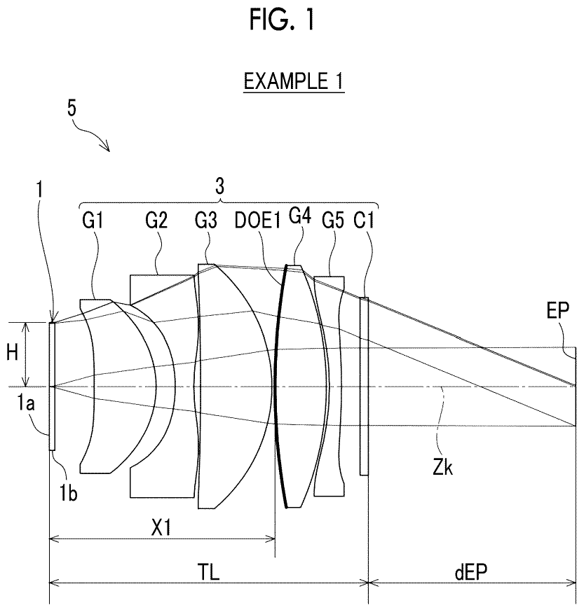

A cross-sectional view of a configuration and luminous fluxes of a finder optical system 5 according to one embodiment of the present disclosure is illustrated in FIG. 1. The example illustrated in FIG. 1 corresponds to Example 1 described later. In FIG. 1, an on-axis luminous flux and an off-axis luminous flux corresponding to a maximum diagonal field of view are illustrated as the luminous fluxes. In FIG. 1, a left side is illustrated as a display element side, and a right side is illustrated as an eyepoint side. An eyepoint EP in FIG. 1 does not indicate a shape and indicates a position in an optical axis direction.

The finder optical system 5 comprises a display element 1 and an ocular optical system 3 disposed on the eyepoint side with respect to the display element 1. The display element 1 is an element that displays an image. The display element 1 includes a display surface 1a on which the image is displayed, and a cover member 1b that is an optical element having a shape of a parallel flat plate and not having a refractive power. In the example in FIG. 1, the display surface 1a is positioned on a surface, on the display element side, of the cover member 1b. For example, the display element 1 can be configured as an image display panel consisting of a liquid crystal display element or an organic electroluminescence (EL) display element. The display element 1 and the ocular optical system 3 are disposed at a predetermined air spacing. In a case where the spacing between the display element 1 and the ocular optical system 3 is configured to change during diopter adjustment, providing the air spacing facilitates securing of a spacing for the diopter adjustment.

The display element 1 is an example of an object to be observed. The ocular optical system 3 is used for observing the image displayed on the display surface 1a of the display element 1. That is, the finder optical system 5 is configured such that the image displayed on the display element 1 is observed through the ocular optical system 3.

For example, the ocular optical system 3 in FIG. 1 includes, in order from the display element side to the eyepoint side, a lens G1 having a positive refractive power, a lens G2 having a negative refractive power, a lens G3 having a positive refractive power, a lens G4 having a positive refractive power, a lens G5 having a negative refractive power, and a cover member C1. The cover member C1 is an optical element having a shape of a parallel flat plate and not having a refractive power.

The ocular optical system 3 preferably includes two or more positive lenses and one or more negative lenses. Doing so achieves an advantage in correcting a chromatic aberration while achieving reduction in size.

The ocular optical system 3 preferably includes two or more aspherical lenses. Doing so achieves an advantage in favorable aberration correction. The ocular optical system 3 may be configured to include two or more aspherical lenses and one or more spherical lenses. Doing so achieves an advantage in performing favorable aberration correction while achieving reduction in cost.

One or more diffraction elements are disposed in the finder optical system 5. The diffraction element is a type of optical element and is the same as a so-called diffractive optical element, which will be referred to as a diffraction element in the present specification. The diffraction element has a negative dispersion value and high anomalous dispersibility. Thus, a high chromatic aberration correction effect can be obtained. Using the diffraction element can reduce a burden of aberration correction for other lenses and thus, achieves an advantage in establishing both of reduction in size and high performance.

At least one diffraction element is configured as a first diffraction element DOE1 including a liquid crystal diffraction element. For example, in the example in FIG. 1, the first diffraction element DOE1 is provided on a surface, on the display element side, of the lens G4. For simplification of the configuration, the first diffraction element DOE1 may be configured to consist of a liquid crystal diffraction element. The liquid crystal diffraction element is configured to include an optically anisotropic layer that is formed using a composition including a liquid crystal compound and that has a liquid crystal alignment pattern in which a direction of an optical axis derived from the liquid crystal compound rotationally changes continuously along at least one in-plane direction. A detailed configuration of the liquid crystal diffraction element will be described later.

An optical surface of the liquid crystal diffraction element can have a surface shape without a physical shape of a level difference and can be configured as a plane or a curved surface. Thus, an optical surface of the first diffraction element DOE1 can also be configured as a plane or a curved surface without a physical shape of a level difference. In a relief diffractive optical surface having a physical shape of a level difference, light scattered by the level difference may cause flare, which decreases resolution. However, the optical surface of the liquid crystal diffraction element can eliminate such an issue. In addition, while a closely attached multilayer diffractive optical element requires technically advanced and expensive processing, the liquid crystal diffraction element does not require such processing. Furthermore, the liquid crystal diffraction element has an advantage of enabling a control corresponding to a polarization state of light.

The first diffraction element DOE1 is disposed to satisfy Conditional Expression (1). TL denotes a distance on an optical axis from the display surface 1a of the display element 1 to a surface of the finder optical system 5 closest to the eyepoint side. X1 denotes a distance on the optical axis from the display surface 1a of the display element 1 to the optical surface of the first diffraction element DOE1. In the present specification, an optical surface of the diffraction element related to conditional expressions is a surface in contact with air out of a surface, on the display element side, of the diffraction element and a surface, on the eyepoint side, of the diffraction element. For example, the distance TL and the distance X1 are illustrated in FIG. 1. Disposing the first diffraction element DOE1 within a range satisfying Conditional Expression (1) can favorably obtain a chromatic aberration correction effect.

0.05≤X1/TL≤1 (1)

The finder optical system 5 preferably satisfies Conditional Expression (2). H denotes a half value of the longest diameter of a display region in the display element 1. f denotes a focal length of the finder optical system 5. For example, the half value H of the longest diameter of the display region is illustrated in FIG. 1. Ensuring that a corresponding value of Conditional Expression (2) is not less than or equal to its lower limit achieves an advantage in achieving a high finder magnification. Ensuring that the corresponding value of Conditional Expression (2) is not greater than or equal to its upper limit achieves an advantage in reduction in size. In order to obtain more favorable characteristics, the finder optical system 5 more preferably satisfies Conditional Expression (2-1) and further preferably satisfies Conditional Expression (2-2).

0.3<H/f<0.7 (2)

0.35<H/f<0.6 (2-1)

0.4<H/f<0.5 (2-2)

The display region is a region in which the image is actually displayed on the display surface 1a. For example, in a case where the display element 1 comprises the display surface 1a of an aspect ratio of 4:3 in which a plurality of pixels are disposed and where an image of an aspect ratio of 3:2 is displayed on a part of the display surface 1a, the display region refers to a region in which the image of the aspect ratio of 3:2 is displayed. Accordingly, a diameter of the display element 1 does not necessarily match the longest diameter of the display region.

In the present specification, the term “longest diameter of the display region in the display element 1” related to H means a value of twice a distance between an optical axis Zk and a point most separated from the optical axis Zk in a diameter direction in the display region of which a centroid matches the optical axis Zk. For example, in a case where the display region is a rectangle, a length of half of a diagonal line of the display region can be set as H. For example, in a case where the display region is a perfect circle, a radius of the display region can be set as H. In a case where the display region is an ellipse, half of the longest diameter (major axis) among diameters of the display region can be set as H.

The finder optical system 5 preferably satisfies Conditional Expression (3). dEP denotes a distance on the optical axis from the surface of the finder optical system 5 closest to the eyepoint side to the eyepoint EP. For example, the distance dEP is illustrated in FIG. 1. In a case where the eyepoint EP is a range instead of one position, dEP denotes a distance on the optical axis from the surface of the finder optical system 5 closest to the eyepoint side to a point on the optical axis closest to the eyepoint side within the range. f denotes the focal length of the finder optical system 5. For a lower limit of Conditional Expression (3), f/dEP>0 is established because of f>0 and dEP>0. Ensuring that a corresponding value of Conditional Expression (3) is not greater than or equal to its upper limit achieves an advantage in securing a high finder magnification and a long eye relief. In order to obtain more favorable characteristics, the finder optical system 5 more preferably satisfies Conditional Expression (3-1) and further preferably satisfies Conditional Expression (3-2).

0<f/dEP<0.95 (3)

0<f/dEP<0.9 (3-1)

0<f/dEP<0.85 (3-2)

While the finder optical system 5 in FIG. 1 includes only one diffraction element, the finder optical system 5 of the present disclosure may be configured to include a plurality of diffraction elements. For example, the finder optical system 5 may be configured to include two or three or more first diffraction elements DOE1. Doing so achieves an advantage in achieving high performance.

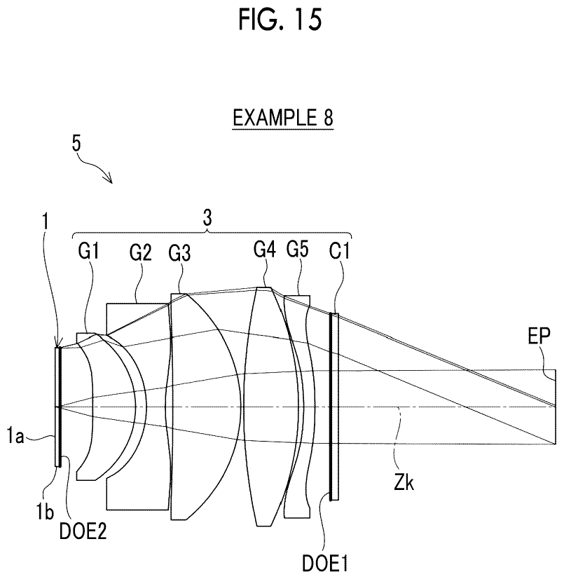

In a case where the finder optical system 5 of the present disclosure includes a plurality of diffraction elements, at least one of the plurality of diffraction elements may be configured as a second diffraction element DOE2 including a liquid crystal diffraction element, as in the example illustrated in FIG. 15, described later. For simplification of the configuration, the second diffraction element DOE2 may be configured to consist of a liquid crystal diffraction element. As described above, the liquid crystal diffraction element has multiple advantages. Like the first diffraction element DOE1, an optical surface of the second diffraction element DOE2 can also be configured as a plane or a curved surface without a physical shape of a level difference.

The second diffraction element DOE2 is disposed to satisfy Conditional Expression (4). TL denotes the distance on the optical axis from the display surface 1a of the display element 1 to the surface of the finder optical system 5 closest to the eyepoint side. X2 denotes a distance on the optical axis from the display surface 1a of the display element 1 to the optical surface of the second diffraction element DOE2. For example, a distance on the optical axis from the display surface 1a of the display element 1 to a surface, on the eyepoint side, of the second diffraction element DOE2 in the example in FIG. 15 corresponds to X2.

0≤X2/TL<0.05 (4)

By disposing the second diffraction element DOE2 within a range satisfying Conditional Expression (4), a ray emitted from an edge part of the display surface 1a separated from the optical axis Zk can be configured to be efficiently guided to the eyepoint EP to be used for observation. Accordingly, since a larger edge part light quantity can be secured, an image having a brighter edge part can be observed. Particularly, since the finder optical system 5 having a high finder magnification and a long eye relief tends to have more light shielding of the ray emitted from the edge part of the display surface 1a, it is effective to dispose the second diffraction element DOE2 within the range satisfying Conditional Expression (4).

In order to guide the ray emitted from the edge part of the display surface 1a via the second diffraction element DOE2 as described above, it is preferable that an element having a refractive power is configured not to be disposed between the second diffraction element DOE2 and the display surface 1a of the display element 1. However, an element such as a parallel flat plate or a polarizing plate not having a refractive power may be disposed between the second diffraction element DOE2 and the display surface 1a of the display element 1.

In a case where the finder optical system 5 includes the second diffraction element DOE2, a sign of a phase difference function of the first diffraction element DOE1 is preferably different from a sign of a phase difference function of the second diffraction element DOE2. By doing so, the first diffraction element DOE1 and the second diffraction element DOE2 can be configured to operate in a direction in which aberrations generated by the first diffraction element DOE1 and the second diffraction element DOE2 cancel each other out. Thus, an advantage in obtaining further high optical performance in addition to the effect of each diffraction element is achieved. Particularly, the sign of the phase difference function of the first diffraction element DOE1 and the sign of the phase difference function of the second diffraction element DOE2 are preferably different from each other in the entire range of an effective diameter of the first diffraction element DOE1 and the entire range of an effective diameter of the second diffraction element DOE2.

The diffraction element included in the finder optical system 5 is preferably provided on a surface of an optical element. Examples of the optical element on which the diffraction element is provided include a lens, a cover member, a filter, and a prism. A surface shape of the optical element on which the diffraction element is provided is preferably a plane or a curved surface. The term “curved surface” includes a spherical surface and an aspherical surface.

Generally, the diffraction element has a small thickness in the optical axis direction. In addition, the diffraction element can be easily provided on a surface of an optical element having a small thickness and a shape of a parallel flat plate. According to this, arrangement of the diffraction element is less restricted compared to that of a general lens, and a degree of freedom in design is increased in a system using the diffraction element. Thus, an advantage in achieving reduction in size and high performance is achieved. Particularly, in a case where a main part of the diffraction element is a liquid crystal diffraction element, the above issue related to flare is not present. Thus, since other optical elements can be disposed close to the diffraction element, an advantage in achieving further reduction in size is achieved.

A lens having a refractive power may be configured to be disposed adjacent to at least one optical element on at least one of an object side or an image side of the optical element among optical elements on which the diffraction element is provided. In such a configuration, a minimum distance Dmin in the optical axis direction between the optical surface of the diffraction element provided on the surface of the optical element and an optical surface of the lens disposed adjacent to the optical element can be set to a very small value. For example, the minimum spacing Dmin can be set to be less than or equal to 1.8 mm. In order to achieve reduction in size, the minimum spacing Dmin is preferably less than or equal to 0.5 mm. The minimum spacing Dmin is not necessarily a spacing on the optical axis and may be a spacing between surfaces within an effective diameter of each element. For example, the minimum spacing Dmin may be a spacing in the edge part separated from the optical axis Zk. That is, the lens can be disposed very close to the optical element on which the diffraction element is provided, at not only a position on the optical axis but also the edge part separated from the optical axis.

A lens having a refractive power may also be configured to be disposed on both of the object side and the image side of at least one optical element among the optical elements on which the diffraction element is provided. In the example in FIG. 1, the lens G3 and the lens G5 are disposed on the object side and the image side, respectively, of the lens G4 that is an optical element on which the first diffraction element DOE1 is provided. In the optical element at a position at which the lens having a refractive power is disposed on both of the object side and the image side in the finder optical system 5, an on-axis luminous flux and an off-axis luminous flux are separated from each other, and the luminous fluxes spread, as illustrated in FIG. 1. Disposing the diffraction element at such a position enables effective aberration correction and thus, achieves an advantage in achieving high performance.

In a case where the diffraction element is provided on the surface of the optical element, an Abbe number νd_op based on a d line for the optical element on which the diffraction element is provided is preferably greater than or equal to 35 and less than 100. Doing so enables use of a general material that is not special and thus, can prevent an increase in cost. Doing so also enables selection of a material having high transmittance and thus, achieves an advantage in observing a brighter image. In a case where the diffraction element is provided on a bonding surface of a cemented lens, an Abbe number based on the d line for lenses on both sides of the bonding surface is preferably greater than or equal to 35 and less than 100.

In a case where the diffraction element is provided on the surface of the optical element, transmittance Td_op on the d line for the optical element on which the diffraction element is provided is preferably greater than or equal to 98%. Doing so achieves an advantage in observing a brighter image. In a case where the diffraction element is provided on the bonding surface of the cemented lens, transmittance on the d line for the cemented lens is preferably greater than or equal to 98%.

In a case where a distance on the optical axis from the display surface 1a of the display element 1 to the optical element in the finder optical system 5 is denoted by X, transmittance Td_part on the d line for a partial optical system consisting of all optical elements disposed within a range of 0.05≤X/TL≤1 is preferably greater than or equal to 92%. Doing so achieves an advantage in observing a brighter image.

Examples of a measuring method of the transmittance include a measuring method using Spectrophotometer V-650 manufactured by JASCO Corporation.

A thickness, in the optical axis direction, of a region having a diffraction action of the diffraction element is preferably less than or equal to 10 μm. Doing so achieves an advantage in having higher transmittance and thus, achieves an advantage in observing a brighter image. For example, the thickness, in the optical axis direction, of the region having the diffraction action of the diffraction element can be measured using a scanning electron microscope (SEM).

All lenses having a refractive power included in the ocular optical system 3 may be configured as non-cemented single lenses. Doing so can increase the degree of freedom in design and thus, achieves an advantage in correcting various aberrations.

The number of lenses having a refractive power included in the finder optical system 5 is preferably four or five. Doing so achieves an advantage in providing a configuration that is reduced in size by decreasing the number of lenses while favorably correcting an overall aberration.

The example illustrated in FIG. 1 is merely an example, and various modifications can be made without departing from the gist of the disclosed technology. The number of lenses having a refractive power and the number of cover members included in the ocular optical system of the present disclosure may be different from the numbers in the example in FIG. 1. For example, while the lenses having a refractive power in the ocular optical system 3 in FIG. 1 are three positive lenses and two negative lenses, the lenses having a refractive power in the ocular optical system may be configured to be three positive lenses and one negative lens in the disclosed technology. Shapes of the lenses included in the ocular optical system may also be different from the shapes in the example in FIG. 1.

The above preferable configurations and available configurations including the configurations related to the conditional expressions can be combined in any manner and are preferably selectively adopted, as appropriate, in accordance with required specifications. The conditional expressions preferably satisfied by the finder optical system 5 of the present disclosure are not limited to the conditional expressions described in the form of an expression and include all conditional expressions that can be obtained by combining lower limits and upper limits in any manner from the preferable, more preferable, and further preferable conditional expressions.

For example, the finder optical system 5 of a preferable aspect of the present disclosure comprises the display element 1 and the ocular optical system 3 disposed on the eyepoint side with respect to the display element 1, in which one or more diffraction elements are disposed in the finder optical system 5, at least one of the diffraction elements is the first diffraction element DOE1 including a liquid crystal diffraction element, and Conditional Expression (1) is satisfied.

Next, examples of the finder optical system 5 of the present disclosure will be described with reference to the drawings. Reference numerals provided to constituents of a cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A configuration of the finder optical system 5 of Example 1 is illustrated in FIG. 1, and its illustration method and configuration are described above. Thus, duplicate descriptions will be partially omitted. The finder optical system 5 of Example 1 comprises, in order from the display element side to the eyepoint side, the display element 1 and the ocular optical system 3. The ocular optical system 3 includes, in order from the display element side to the eyepoint side, five lenses including the lenses G1 to G5 and the cover member C1. The first diffraction element DOE1 is provided on the surface, on the display element side, of the lens G4.

For the finder optical system 5 of Example 1, Table 1 shows basic lens data, Table 2 shows specifications, Table 3 shows an aspherical coefficient, and Table 4 shows a phase difference coefficient.

Table 1 is described as follows. A column of Sn shows a surface number of each surface in a case where a surface on which the display surface 1a of the display element 1 is disposed is referred to as a first surface and where the number is increased by one at a time to the eyepoint side. A column of R shows a curvature radius of each surface. A column of D shows a surface spacing on the optical axis between each surface and its adjacent surface on the eyepoint side. A column of Nd shows a refractive index with respect to the d line for each constituent. A column of νd shows an Abbe number based on the d line for each constituent.

Table 1 also shows the eyepoint EP. A field of Sn for a surface corresponding to the eyepoint EP shows a surface number and a text (EP). In Table 1, a sign of a curvature radius of a surface having a convex shape facing the display element side is positive, and a sign of a curvature radius of a surface having a convex shape facing the eyepoint side is negative. A mark * is provided to a surface number of an aspherical surface, and a field of a curvature radius of the aspherical surface shows a numerical value of a paraxial curvature radius. In Table 1, a mark ** is provided to a surface number corresponding to the diffraction element.

Table 2 shows the focal length f of the finder optical system 5, a diagonal field of view at a full angle of view, and the half value H of the longest diameter of the display region. The diagonal field of view is a field of view in a diagonal direction in a rectangular visual field.

In Table 3, a row of Sn shows the surface number of the aspherical surface, rows of KA and Am show a numerical value of the aspherical coefficient for each aspherical surface. m is an integer greater than or equal to 3. For example, m=3, 4, 5, . . . , 16 is established for the aspherical surface of Example 1. In the numerical value of the aspherical coefficient in Table 3, “E±n” (n: integer) means “×10^{±n}”. KA and Am are aspherical coefficients in an aspheric equation represented by the following expression.

$$Z d = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Zk)
h: a height (a distance from the optical axis Zk to the aspherical surface)
C: a reciprocal of the paraxial curvature radius
KA and Am: aspherical coefficients
Σ in the aspheric equation means a sum total with respect to m.

In Table 4, the row of Sn shows the surface number of the surface corresponding to the diffraction element, and a row of Pj (j=2, 4, and 6) shows a numerical value of the phase difference coefficient for each diffraction element. In the numerical value of the phase difference coefficient in Table 4, “E±n” (n: integer) means “×10^{±n}”. Pj is a phase difference coefficient in a phase difference function PH(h) represented by the following expression.

$$PH ( h ) = \sum Pj \times {h}^{j}$$

where
Pj: a phase difference coefficient
h: a height (a distance from the optical axis Zk to the surface corresponding to the diffraction element)
Σ in the phase difference function PH(h) means a sum total with respect to j.

In data of each table, a degree unit is used for an angle, and a millimeter (mm) unit is used for a length. However, since the optical system can also be proportionally enlarged or proportionally reduced to be used, other appropriate units can also be used. Each table below shows numerical values rounded in a predetermined number of digits.

TABLE 1
Example 1

| Sn | R | D | Nd | νd |
|---|---|---|---|---|
| 1 | ∞ | 0.5000 | 1.51900 | 64.90 |
| 2 | ∞ | 3.8000 | | |
| *3 | −990.6320 | 5.9827 | 1.85135 | 40.10 |
| *4 | −10.1885 | 1.8394 | | |
| *5 | −14.7692 | 1.7972 | 1.63351 | 23.63 |
| *6 | 17.8085 | 0.6430 | | |
| 7 | −300.9022 | 6.8788 | 1.83481 | 42.74 |
| 8 | −16.6167 | 0.3011 | | |
| **9 | 70.1360 | 4.8856 | 1.85150 | 40.78 |
| 10 | −31.6736 | 0.3000 | | |
| *11 | −24.4646 | 1.1625 | 1.63351 | 23.63 |
| *12 | −52.2275 | 1.7803 | | |
| 13 | ∞ | 0.8000 | 1.49023 | 57.50 |
| 14 | ∞ | 20.0000 | | |
| 15 (EP) | ∞ | | | |

TABLE 2
Example 1

| | |
|---|---|
| f | 14.45 |
| Diagonal Field of View | 46.76° |
| H | 6.35 |

TABLE 3
Example 1

| Sn | 3 | 4 | 5 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 4.4469522E−04 | −6.6461371E−05 | −5.9077338E−04 |
| A5 | −5.1544689E−04 | 3.4799235E−05 | 6.4421516E−05 |
| A6 | 5.8121324E−05 | 1.5329546E−06 | 5.8851407E−08 |
| A7 | 2.0826859E−05 | −1.0908300E−06 | 2.2988164E−07 |
| A8 | −4.0988363E−06 | 1.1427500E−07 | −1.7960922E−07 |
| A9 | −4.4519080E−07 | −1.8766093E−08 | −5.5764638E−08 |
| A10 | 1.1783091E−07 | 1.8974879E−09 | 1.1686198E−08 |
| A11 | 5.0820507E−09 | 3.7598667E−10 | 1.0145124E−09 |
| A12 | −1.7408869E−09 | −6.0772778E−11 | −2.2354529E−10 |
| A13 | −2.7760084E−11 | −1.0193141E−12 | −7.5840065E−12 |
| A14 | 1.2925861E−11 | 4.0337837E−13 | 1.7319696E−12 |
| A15 | 5.5185840E−14 | −4.1981694E−15 | 2.0788456E−14 |
| A16 | −3.8200054E−14 | −6.4018506E−16 | −4.7023329E−15 |
| Sn | 6 | 11 | 12 |
| KA | 1.0000000E+00 | 1.0000000E+00 | 1.0000000E+00 |
| A3 | 0.0000000E+00 | 0.0000000E+00 | 0.0000000E+00 |
| A4 | −5.5741516E−04 | 2.3353735E−05 | 1.8149395E−04 |
| A5 | −1.7577829E−05 | 8.2955662E−05 | −2.4903314E−06 |
| A6 | 5.7653906E−06 | −1.5266873E−05 | −3.4301700E−06 |
| A7 | 1.8668147E−07 | −1.7550785E−06 | 3.4885822E−08 |
| A8 | −3.8495782E−08 | 4.1822691E−07 | −1.7653392E−08 |
| A9 | −8.7965471E−10 | 1.7080331E−08 | 7.4459979E−10 |
| A10 | 1.6189716E−10 | −4.8509951E−09 | 2.2673766E−09 |
| A11 | 2.2024702E−12 | −8.6647527E−11 | −8.0139631E−12 |
| A12 | −3.8897431E−13 | 2.8889654E−11 | −3.5427966E−11 |
| A13 | −2.8429883E−15 | 2.2884139E−13 | −5.0588742E−15 |
| A14 | 4.7256916E−16 | −8.7068480E−14 | 2.2134621E−13 |
| A15 | 1.4847793E−18 | −2.5790940E−16 | 2.7733021E−16 |
| A16 | −2.1761848E−19 | 1.0579153E−16 | −4.9874097E−16 |

TABLE 4
Example 1

| Sn | 9 |
|---|---|
| P2 | −8.8865E+00 |
| P4 | −1.5920E−03 |
| P6 | −9.6550E−06 |

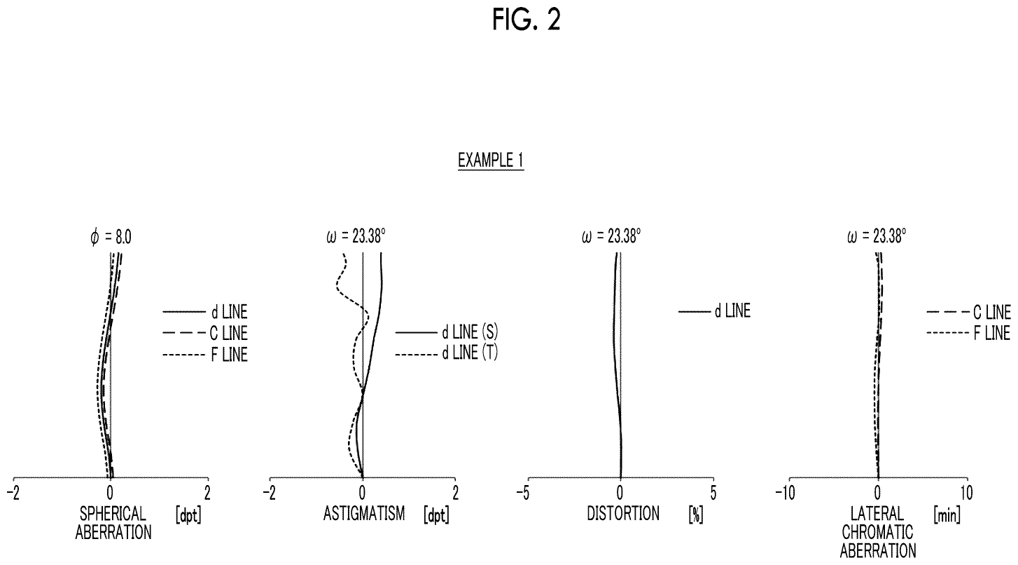

FIG. 2 illustrates each aberration diagram of the finder optical system 5 of Example 1. FIG. 2 illustrates a spherical aberration, an astigmatism, a distortion, and a lateral chromatic aberration in this order from the left. In the spherical aberration diagram, aberrations on the d line, a C line, and an F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. The unit “dpt” on horizontal axes of the spherical aberration diagram and the astigmatism diagram denotes diopter. The unit “min” on a horizontal axis of the lateral chromatic aberration diagram denotes a minute for an angle. In the spherical aberration diagram, a diameter of the eyepoint EP in units of millimeters (mm) is shown after “Φ=”. In other aberration diagrams, a value of the diagonal field of view at a half angle of view is shown after “ω=”.

Symbols, meanings, description methods, and illustration methods of each data related to Example 1 are the same as those in the following examples unless otherwise specified. Thus, duplicate descriptions will be omitted below.

### Example 2

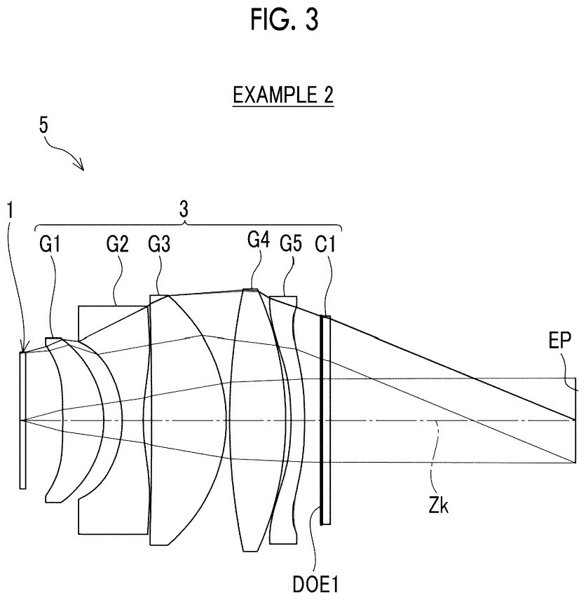

A configuration and luminous fluxes of the finder optical system 5 of Example 2 are illustrated in FIG. 3. The finder optical system 5 of Example 2 comprises, in order from the display element side to the eyepoint side, the display element 1 and the ocular optical system 3. The ocular optical system 3 includes, in order from the display element side to the eyepoint side, the lens G1 having a positive refractive power, the lens G2 having a negative refractive power, the lens G3 having a positive refractive power, the lens G4 having a positive refractive power, the lens G5 having a negative refractive power, and the cover member C1. The cover member C1 is an optical element having a shape of a parallel flat plate and not having a refractive power. The first diffraction element DOE1 is provided on a surface, on the display element side, of the cover member C1.

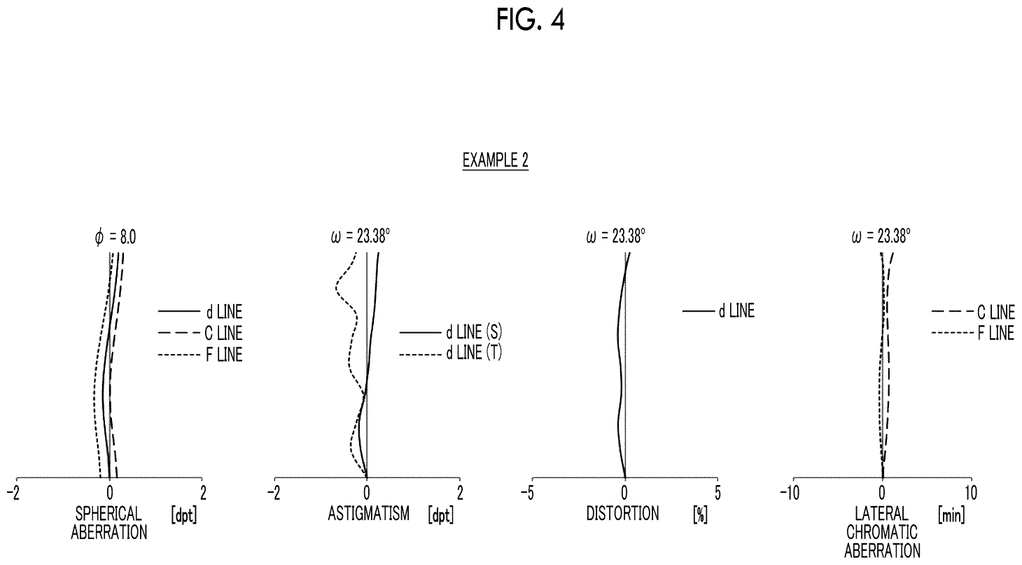

For the finder optical system 5 of Example 2, Table 5 shows basic lens data, Table 6 shows specifications, Table 7 shows an aspherical coefficient, Table 8 shows a phase difference coefficient, and FIG. 4 illustrates each aberration diagram.

TABLE 5
Example 2

| Sn | R | D | Nd | νd |
|---|---|---|---|---|
| 1 | ∞ | 0.5000 | 1.51900 | 64.90 |
| 2 | ∞ | 3.3294 | | |
| *3 | −126.9268 | 3.6755 | 1.85135 | 40.10 |
| *4 | −9.2552 | 1.6551 | | |
| *5 | −9.8701 | 1.8796 | 1.63351 | 23.63 |
| *6 | 17.6814 | 0.7564 | | |
| 7 | −436.0085 | 6.6939 | 1.80420 | 46.50 |
| 8 | −15.8219 | 0.3000 | | |
| 9 | 62.4146 | 5.0360 | 1.88300 | 40.80 |
| 10 | −31.3085 | 0.4744 | | |
| *11 | −27.6583 | 1.1625 | 1.63351 | 23.63 |
| *12 | −39.1784 | 1.5000 | | |
| **13 | ∞ | 0.8000 | 1.49023 | 57.50 |
| 14 | ∞ | 22.0000 | | |
| 15 (EP) | ∞ | | | |

TABLE 6
Example 2

| | |
|---|---|
| f | 14.47 |
| Diagonal Field of View | 46.76° |
| H | 6.35 |

TABLE 7
Example 2

| Sn | 3 | 4 | 5 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 4.4818355E−04 | 1.1265426E−03 | 1.3432987E−03 |
| A5 | −5.4336754E−04 | −4.8598751E−04 | −6.8997353E−04 |
| A6 | 3.8016075E−05 | 1.6306838E−05 | 7.9152713E−05 |
| A7 | 2.1256105E−05 | 2.1673602E−05 | 2.4229621E−05 |
| A8 | −2.8823252E−06 | −1.5023548E−06 | −4.9257944E−06 |
| A9 | −4.4728037E−07 | −6.3831509E−07 | −4.5862310E−07 |
| A10 | 8.4416716E−08 | 6.1689497E−08 | 1.2186458E−07 |
| A11 | 5.0708030E−09 | 8.9934638E−09 | 4.7342658E−09 |
| A12 | −1.2523986E−09 | −1.0622085E−09 | −1.5771425E−09 |
| A13 | −2.7808173E−11 | −5.2667425E−11 | −2.6013814E−11 |
| A14 | 9.2616912E−12 | 7.5515479E−12 | 1.0204614E−11 |
| A15 | 5.6444740E−14 | 8.0463336E−14 | 5.9881245E−14 |
| A16 | −2.7161854E−14 | −1.6725663E−14 | −2.5823286E−14 |
| Sn | 6 | 11 | 12 |
| KA | 1.0000000E+00 | 1.0000000E+00 | 1.0000000E+00 |
| A3 | 0.0000000E+00 | 0.0000000E+00 | 0.0000000E+00 |
| A4 | −4.4121777E−04 | −4.3309774E−04 | −2.5386515E−04 |
| A5 | −1.6928568E−05 | 8.6183717E−05 | 2.6791665E−06 |
| A6 | 4.0200225E−06 | −4.1742945E−06 | 6.8858640E−06 |
| A7 | 1.7358793E−07 | −1.8193343E−06 | −3.4619445E−07 |
| A8 | −2.4738269E−08 | 2.6585711E−07 | −1.1812946E−07 |
| A9 | −7.9758975E−10 | 1.7790213E−08 | 9.5438421E−09 |
| A10 | 9.9869298E−11 | −3.5978137E−09 | 1.9273143E−09 |
| A11 | 1.9509579E−12 | −9.0753509E−11 | −1.1116602E−10 |
| A12 | −2.3006943E−13 | 2.3106855E−11 | −1.9752677E−11 |
| A13 | −2.4623029E−15 | 2.4068678E−13 | 6.1858437E−13 |
| A14 | 2.5967231E−16 | −7.4300091E−14 | 1.0383676E−13 |
| A15 | 1.2579109E−18 | −2.7186949E−16 | −1.2731536E−15 |
| A16 | −1.0302080E−19 | 9.7029161E−17 | −2.2039712E−16 |

TABLE 8
Example 2

| Sn | 13 |
|---|---|
| P2 | −1.5561E+01 |
| P4 | 1.0588E−01 |
| P6 | −9.3460E−04 |

### Example 3

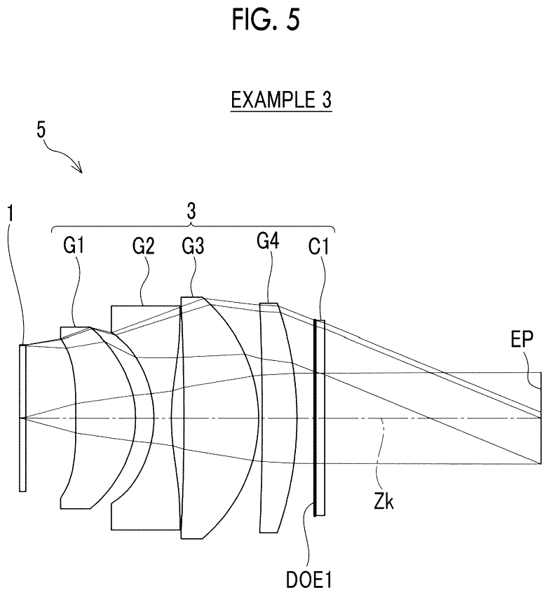

A configuration and luminous fluxes of the finder optical system 5 of Example 3 are illustrated in FIG. 5. The finder optical system 5 of Example 3 comprises, in order from the display element side to the eyepoint side, the display element 1 and the ocular optical system 3. The ocular optical system 3 includes, in order from the display element side to the eyepoint side, the lens G1 having a positive refractive power, the lens G2 having a negative refractive power, the lens G3 having a positive refractive power, the lens G4 having a positive refractive power, and the cover member C1. The cover member C1 is an optical element having a shape of a parallel flat plate and not having a refractive power. The first diffraction element DOE1 is provided on the surface, on the display element side, of the cover member C1.

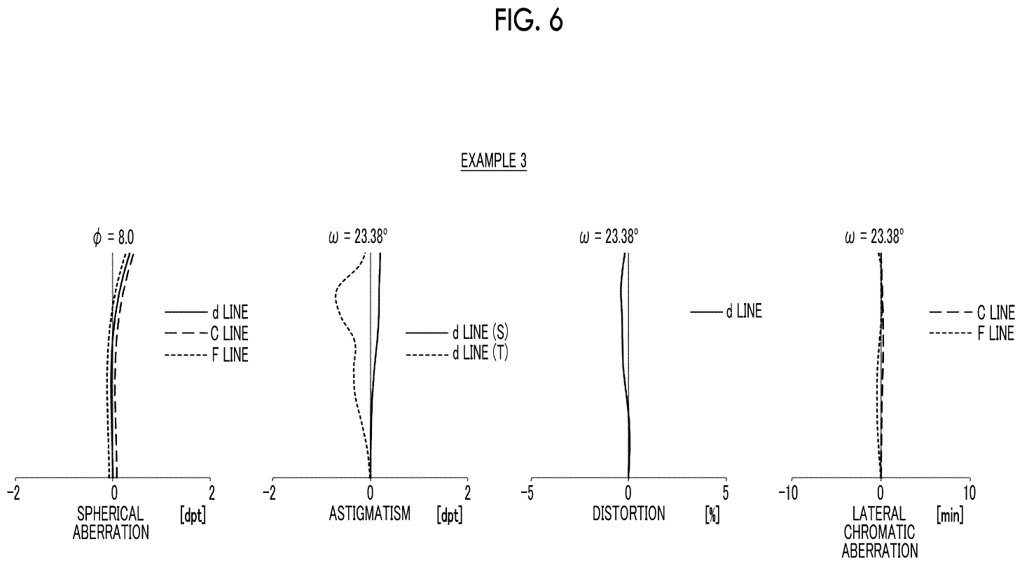

For the finder optical system 5 of Example 3, Table 9 shows basic lens data, Table 10 shows specifications, Table 11 shows an aspherical coefficient, Table 12 shows a phase difference coefficient, and FIG. 6 illustrates each aberration diagram.

TABLE 9
Example 3

| Sn | R | D | Nd | νd |
|---|---|---|---|---|
| 1 | ∞ | 0.5000 | 1.51900 | 64.90 |
| 2 | ∞ | 4.1600 | | |
| *3 | −498.7025 | 4.9841 | 1.85135 | 40.10 |
| *4 | −9.6281 | 1.5139 | | |
| *5 | −10.4986 | 1.4564 | 1.63351 | 23.63 |
| *6 | 20.2260 | 1.0485 | | |
| 7 | −204.3388 | 6.2115 | 1.80420 | 46.50 |
| 8 | −14.1852 | 0.3000 | | |
| 9 | −244.9143 | 2.8305 | 1.81600 | 46.62 |
| 10 | −31.4516 | 1.5000 | | |
| **11 | ∞ | 0.8000 | 1.49023 | 57.50 |
| 12 | ∞ | 18.0000 | | |
| 13 (EP) | ∞ | | | |

TABLE 10
Example 3

| | |
|---|---|
| f | 14.57 |
| Diagonal Field of View | 46.76° |
| H | 6.35 |

TABLE 11
Example 3

| Sn | 3 | 4 | 5 | 6 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −5.9399148E−04 | −6.6567358E−04 | −9.4138410E−04 | −2.7859338E−04 |
| A5 | −2.8124923E−04 | 5.7132628E−05 | 1.8590678E−04 | −1.1640688E−05 |
| A6 | 7.9580182E−05 | 3.8010429E−05 | 3.2589632E−05 | 2.1689886E−06 |
| A7 | 7.9109437E−06 | −1.3015492E−06 | −2.7025337E−06 | 1.0398784E−07 |
| A8 | −3.1803839E−06 | −1.0338175E−06 | −1.5632164E−06 | −1.2000773E−08 |
| A9 | −1.2539625E−07 | 1.3927962E−09 | −2.8480377E−08 | −4.3427104E−10 |
| A10 | 6.2726166E−08 | 1.7902590E−08 | 4.4876560E−08 | 4.4752133E−11 |
| A11 | 1.0733741E−09 | 6.6255245E−11 | 9.5143737E−10 | 9.4929632E−13 |
| A12 | −6.6313895E−10 | −1.6949801E−10 | −6.6375324E−10 | −9.1276391E−14 |
| A13 | −4.3584734E−12 | −3.2045932E−14 | −8.1386213E−12 | −1.0525015E−15 |
| A14 | 3.5834063E−12 | 7.8687496E−13 | 4.6352901E−12 | 8.0832033E−17 |
| A15 | 6.2626926E−15 | −1.5256601E−15 | 2.3519619E−14 | 4.6218898E−19 |
| A16 | −7.7739216E−15 | −1.3801180E−15 | −1.2049946E−14 | −1.5136413E−20 |

TABLE 12
Example 3

| Sn | 11 |
|---|---|
| P2 | −1.1291E+01 |
| P4 | 1.8212E−02 |
| P6 | −5.3489E−05 |

### Example 4

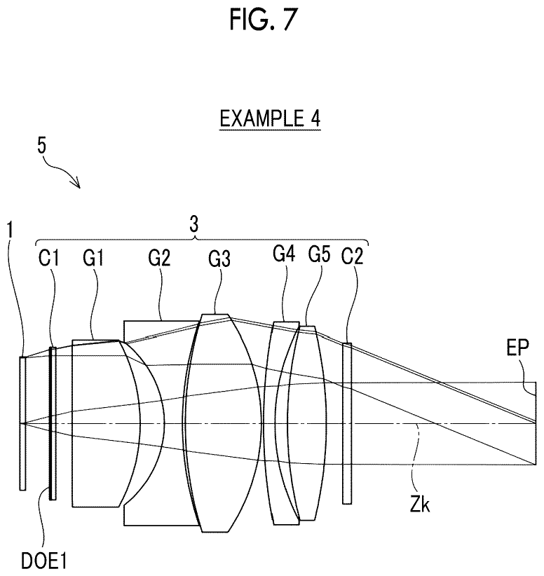

A configuration and luminous fluxes of the finder optical system 5 of Example 4 are illustrated in FIG. 7. The finder optical system 5 of Example 4 comprises, in order from the display element side to the eyepoint side, the display element 1 and the ocular optical system 3. The ocular optical system 3 includes, in order from the display element side to the eyepoint side, the cover member C1, the lens G1 having a positive refractive power, the lens G2 having a negative refractive power, the lens G3 having a positive refractive power, the lens G4 having a negative refractive power, the lens G5 having a positive refractive power, and a cover member C2. The cover member C1 and the cover member C2 are optical elements having a shape of a parallel flat plate and not having a refractive power. The first diffraction element DOE1 is provided on the surface, on the display element side, of the cover member C1.

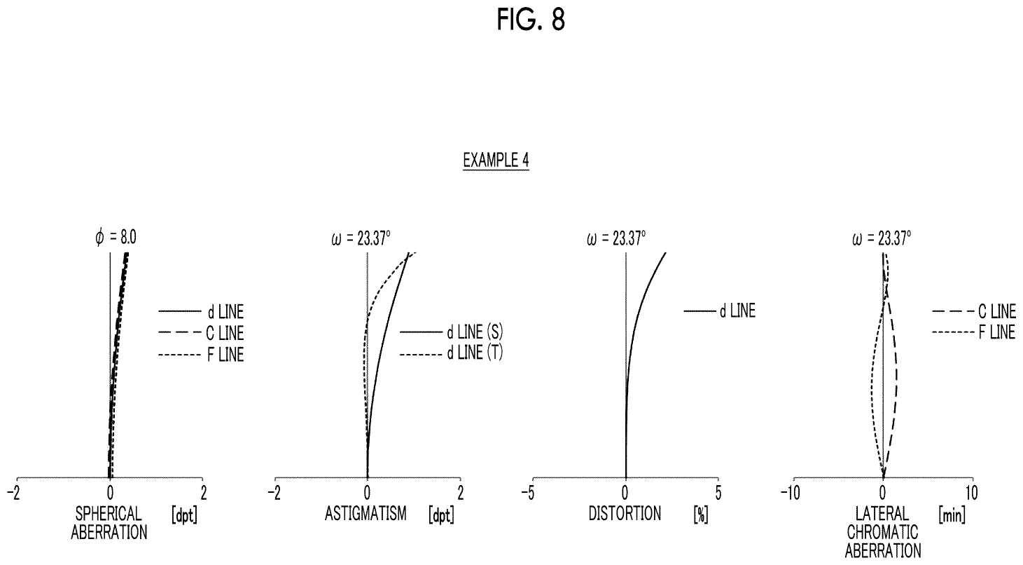

For the finder optical system 5 of Example 4, Table 13 shows basic lens data, Table 14 shows specifications, Table 15 shows a phase difference coefficient, and FIG. 8 illustrates each aberration diagram.

TABLE 13
Example 4

| Sn | R | D | Nd | νd |
|---|---|---|---|---|
| 1 | ∞ | 0.5000 | 1.51900 | 64.90 |
| 2 | ∞ | 2.3000 | | |
| **3 | ∞ | 0.5000 | 1.51900 | 64.90 |
| 4 | ∞ | 1.5002 | | |
| 5 | 1832.6599 | 6.2712 | 2.00100 | 29.13 |
| 6 | −17.4617 | 2.2258 | | |
| 7 | −10.3093 | 1.6692 | 1.63351 | 23.63 |
| 8 | 32.1562 | 0.2680 | | |
| 9 | 36.4438 | 7.0000 | 1.91082 | 35.25 |
| 10 | −19.5459 | 0.2000 | | |
| 11 | 53.3806 | 1.0000 | 1.63351 | 23.63 |
| 12 | 20.8509 | 1.1526 | | |
| 13 | 38.4982 | 3.5854 | 1.80420 | 46.50 |
| 14 | −41.0527 | 1.5000 | | |
| 15 | ∞ | 0.8000 | 1.49023 | 57.50 |
| 16 | ∞ | 17.0000 | | |
| 17 (EP) | ∞ | | | |

TABLE 14
Example 4

| | |
|---|---|
| f | 14.89 |
| Diagonal Field of View | 46.74° |
| H | 6.35 |

TABLE 15
Example 4

| Sn | 3 |
|---|---|
| P2 | −1.3795E+02 |
| P4 | 1.6385E+00 |
| P6 | −1.3118E−02 |

### Example 5

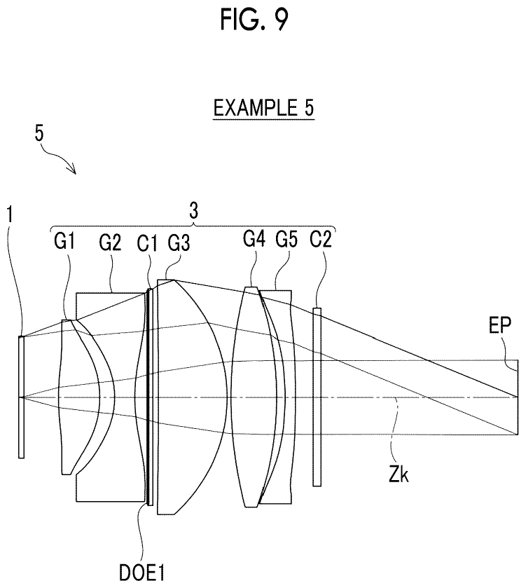

A configuration and luminous fluxes of the finder optical system 5 of Example 5 are illustrated in FIG. 9. The finder optical system 5 of Example 5 comprises, in order from the display element side to the eyepoint side, the display element 1 and the ocular optical system 3. The ocular optical system 3 includes, in order from the display element side to the eyepoint side, the lens G1 having a positive refractive power, the lens G2 having a negative refractive power, the cover member C1, the lens G3 having a positive refractive power, the lens G4 having a positive refractive power, the lens G5 having a negative refractive power, and the cover member C2. The cover member C1 and the cover member C2 are optical elements having a shape of a parallel flat plate and not having a refractive power. The first diffraction element DOE1 is provided on the surface, on the display element side, of the cover member C1.

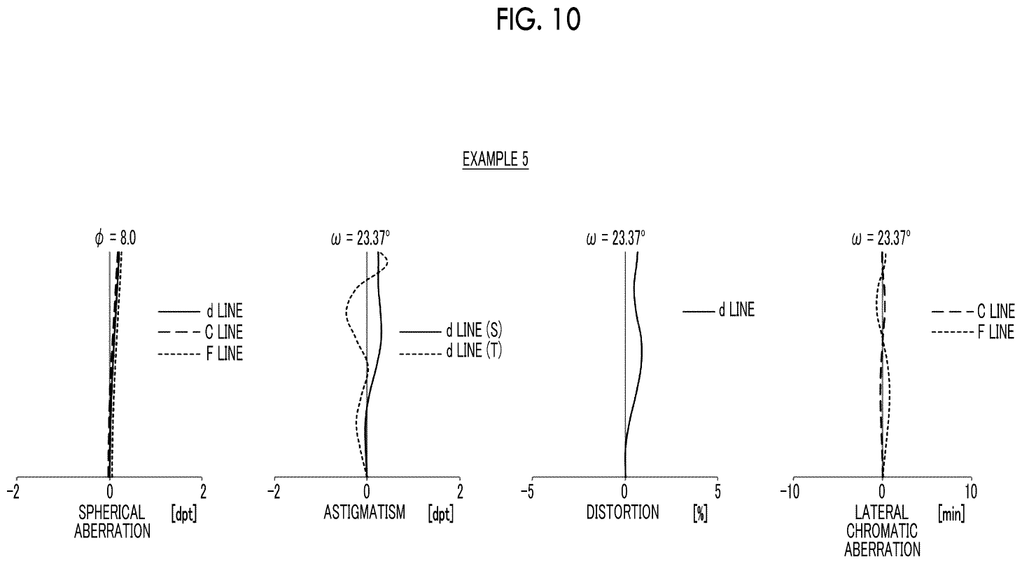

For the finder optical system 5 of Example 5, Table 16 shows basic lens data, Table 17 shows specifications, Table 18 shows an aspherical coefficient, Table 19 shows a phase difference coefficient, and FIG. 10 illustrates each aberration diagram.

TABLE 16
Example 5

| Sn | R | D | Nd | νd |
|---|---|---|---|---|
| 1 | ∞ | 0.5000 | 1.51900 | 64.90 |
| 2 | ∞ | 3.5236 | | |
| *3 | 26.6998 | 4.1921 | 1.85135 | 40.10 |
| *4 | −10.8697 | 1.5098 | | |
| *5 | −9.4129 | 2.0444 | 1.63351 | 23.63 |
| *6 | 19.4343 | 1.3222 | | |
| **7 | ∞ | 0.5000 | 1.51900 | 64.90 |
| 8 | ∞ | 0.5646 | | |
| 9 | −873.0604 | 6.9901 | 1.83481 | 42.72 |
| 10 | −17.2368 | 0.3935 | | |
| 11 | 48.5358 | 4.5813 | 1.88300 | 40.80 |
| 12 | −36.3361 | 0.8508 | | |
| *13 | −30.6173 | 1.0563 | 1.63351 | 23.63 |
| *14 | −131.5374 | 1.7979 | | |
| 15 | ∞ | 0.8000 | 1.49023 | 57.50 |
| 16 | ∞ | 20.0000 | | |
| 17 (EP) | ∞ | | | |

TABLE 17
Example 5

| | |
|---|---|
| f | 14.50 |
| Diagonal Field of View | 46.74° |
| H | 6.35 |

TABLE 18
Example 5

| Sn | 3 | 4 | 5 |
|---|---|---|---|
| KA | 1.0000000E+00 | 1.0000000E+00 | 1.0000000E+00 |
| A3 | −4.4738699E−19 | 4.9802648E−18 | −8.5502190E−20 |
| A4 | 1.6573463E−04 | −1.0285105E−04 | −5.8151878E−04 |
| A5 | 7.4250099E−06 | 1.0116680E−05 | 1.2800994E−04 |
| A6 | −4.3242993E−05 | 2.0134496E−06 | 3.1906555E−06 |
| A7 | −5.9453850E−07 | −2.2971629E−06 | −5.0449684E−07 |
| A8 | 1.6933592E−06 | 6.7431544E−07 | −1.8650455E−08 |
| A9 | 6.4532511E−08 | −9.9988526E−08 | −2.5575174E−09 |
| A10 | −4.5445494E−08 | 1.1781922E−08 | 6.9768865E−12 |
| A11 | −1.2181376E−09 | 7.3897966E−10 | −8.2716661E−12 |
| A12 | 7.2540354E−10 | −3.1652956E−10 | −3.3753873E−12 |
| A13 | 7.4094870E−12 | 4.8091492E−12 | −6.7394979E−13 |
| A14 | −5.8793654E−12 | 2.2701659E−12 | 2.6137912E−14 |
| A15 | −1.6374946E−14 | −1.9416252E−14 | −4.4432694E−15 |
| A16 | 1.9477801E−14 | −7.3328582E−15 | 2.1737918E−15 |
| Sn | 6 | 13 | 14 |
| KA | 1.0000000E+00 | 1.0000000E+00 | 1.0000000E+00 |
| A3 | 8.6490344E−22 | −4.4836518E−23 | −2.2682142E−23 |
| A4 | −1.3629578E−04 | −4.8506808E−05 | −5.6815447E−05 |
| A5 | −5.2482059E−06 | −2.3880634E−06 | −6.3144814E−07 |
| A6 | −2.3034859E−07 | −1.3996222E−07 | 1.7875692E−07 |
| A7 | −6.5578721E−09 | 9.6732405E−09 | 8.3545770E−09 |
| A8 | 7.4538944E−10 | 1.7966314E−09 | −1.3062148E−11 |
| A9 | 1.7491130E−10 | 1.2099341E−10 | 3.7314172E−11 |
| A10 | 2.4039229E−11 | 1.7715247E−11 | 9.6869943E−12 |
| A11 | 2.1567992E−12 | −4.7093925E−13 | 6.5821339E−13 |
| A12 | −3.8389303E−14 | 2.6588948E−14 | 5.3014381E−15 |
| A13 | −4.1507169E−14 | −4.7385502E−15 | 5.6309792E−15 |
| A14 | 2.9731287E−15 | −4.7060189E−16 | 4.6166491E−16 |
| A15 | −1.6707502E−16 | −9.7071684E−18 | −1.1264931E−17 |
| A16 | 6.2244704E−18 | 1.5009030E−18 | −4.4024157E−18 |

TABLE 19
Example 5

| Sn | 7 |
|---|---|
| P2 | −1.7398E+01 |
| P4 | 7.7702E−02 |
| P6 | −2.5648E−04 |

### Example 6

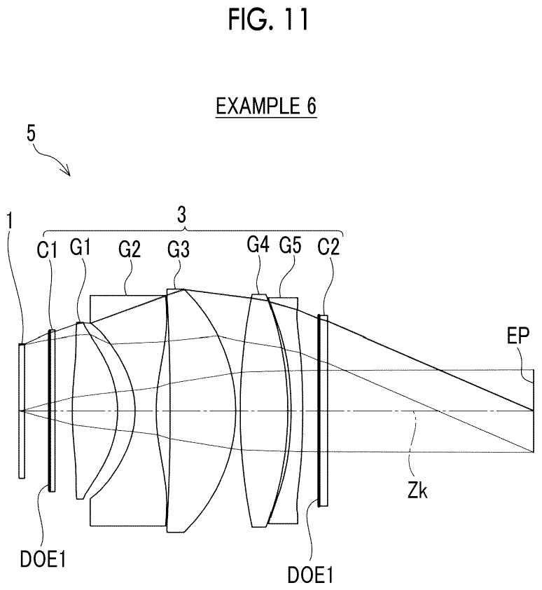

A configuration and luminous fluxes of the finder optical system 5 of Example 6 are illustrated in FIG. 11. The finder optical system 5 of Example 6 comprises, in order from the display element side to the eyepoint side, the display element 1 and the ocular optical system 3. The ocular optical system 3 includes, in order from the display element side to the eyepoint side, the cover member C1, the lens G1 having a positive refractive power, the lens G2 having a negative refractive power, the lens G3 having a positive refractive power, the lens G4 having a positive refractive power, the lens G5 having a negative refractive power, and the cover member C2. The cover member C1 and the cover member C2 are optical elements having a shape of a parallel flat plate and not having a refractive power. The finder optical system 5 of Example 6 includes two first diffraction elements DOE1. The first diffraction element DOE1 is provided on each of the surface, on the display element side, of the cover member C1 and a surface, on the display element side, of the cover member C2.

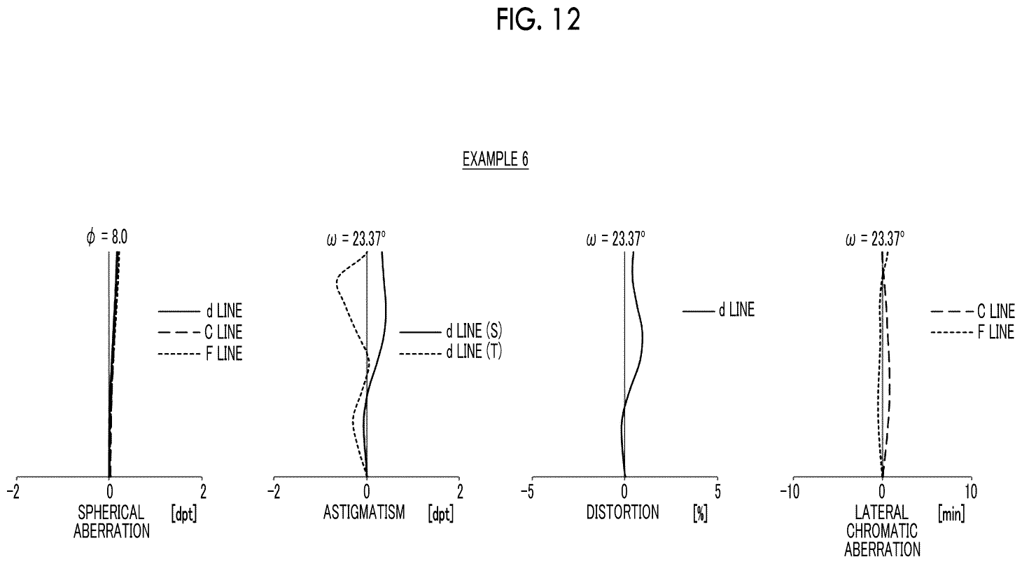

For the finder optical system 5 of Example 6, Table 20 shows basic lens data, Table 21 shows specifications, Table 22 shows an aspherical coefficient, Table 23 shows a phase difference coefficient, and FIG. 12 illustrates each aberration diagram.

TABLE 20
Example 6

| Sn | R | D | Nd | vd |
|---|---|---|---|---|
| 1 | ∞ | 0.5000 | 1.51900 | 64.90 |
| 2 | ∞ | 2.3000 | | |
| **3 | ∞ | 0.5000 | 1.51900 | 64.90 |
| 4 | ∞ | 1.6051 | | |
| *5 | 34.7659 | 4.1764 | 1.85135 | 40.10 |
| *6 | −10.8415 | 1.6085 | | |
| *7 | −9.6977 | 1.9528 | 1.63351 | 23.63 |
| *8 | 20.1585 | 1.2854 | | |
| 9 | −209.9199 | 6.0381 | 1.83481 | 42.72 |
| 10 | −16.8866 | 0.4132 | | |
| 11 | 58.0113 | 4.3365 | 1.90043 | 37.37 |
| 12 | −33.1127 | 0.3000 | | |
| *13 | −35.7957 | 1.0645 | 1.63351 | 23.63 |
| *14 | −98.6523 | 1.5000 | | |
| **15 | ∞ | 0.8000 | 1.49023 | 57.50 |
| 16 | ∞ | 19.0000 | | |
| 17 (EP) | ∞ | | | |

TABLE 21
Example 6

| | |
|---|---|
| f | 13.78 |
| Diagonal Field of View | 46.74° |
| H | 6.35 |

TABLE 22
Example 6

| Sn | 5 | 6 | 7 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 1.2340599E−05 | −2.8375164E−05 | −4.1558011E−04 |
| A5 | 6.8498892E−07 | −8.7054478E−07 | 9.4592377E−05 |
| A6 | −6.9596400E−06 | 3.5515388E−06 | 1.8645309E−06 |
| A7 | 1.7109558E−07 | −2.9824114E−07 | −3.8709866E−07 |
| A8 | −2.1241956E−09 | 7.8490221E−08 | −1.3022307E−08 |
| A9 | 8.3025699E−09 | −1.4922512E−08 | −1.3845719E−09 |
| A10 | −3.5748765E−10 | 1.4584780E−09 | 4.4342938E−11 |
| A11 | 6.1608482E−11 | −7.9054192E−11 | −4.7711483E−13 |
| A12 | 1.3659904E−13 | −3.6818768E−13 | −1.6482662E−12 |
| A13 | −5.3512816E−13 | 3.2281847E−13 | −3.6451978E−13 |
| A14 | −2.8507551E−14 | 3.2502669E−14 | 1.2221980E−14 |
| A15 | −2.0706288E−15 | −1.0284155E−15 | −2.3763434E−15 |
| A16 | 3.1571336E−16 | −7.9947944E−17 | 1.0474835E−15 |
| Sn | 8 | 13 | 14 |
| KA | 1.0000000E+00 | 1.0000000E+00 | 1.0000000E+00 |
| A3 | 0.0000000E+00 | 0.0000000E+00 | 0.0000000E+00 |
| A4 | −1.3765596E−04 | −4.0648015E−05 | −5.9844529E−05 |
| A5 | −4.5229487E−06 | −2.4608313E−06 | −6.6875343E−07 |
| A6 | −1.9876809E−07 | −1.7332688E−07 | 3.0597723E−07 |
| A7 | −5.8066383E−09 | 5.8294855E−09 | 1.7773129E−08 |
| A8 | 5.8923486E−10 | 1.6572058E−09 | 3.0289676E−10 |
| A9 | 1.3936122E−10 | 1.2168927E−10 | 2.3881586E−11 |
| A10 | 1.8935729E−11 | 1.8095910E−11 | 5.4520043E−12 |
| A11 | 1.6674611E−12 | −2.7166869E−13 | 1.7935039E−13 |
| A12 | −2.4308228E−14 | 4.0568684E−14 | −2.8821767E−14 |
| A13 | −2.9394073E−14 | −3.2590125E−15 | 4.9464734E−15 |
| A14 | 2.0716618E−15 | −3.8682079E−16 | 6.4833443E−16 |
| A15 | −1.1440920E−16 | −1.2855526E−17 | 1.9851545E−17 |
| A16 | 3.8487962E−18 | 2.4478179E−19 | −1.1160947E−18 |

TABLE 23
Example 6

| Sn | 3 | 15 |
|---|---|---|
| P2 | −7.2415E+01 | −7.5911E+00 |
| P4 | 1.0934E+00 | 6.3242E−02 |
| P6 | −1.0466E−02 | −5.8068E−04 |

### Example 7

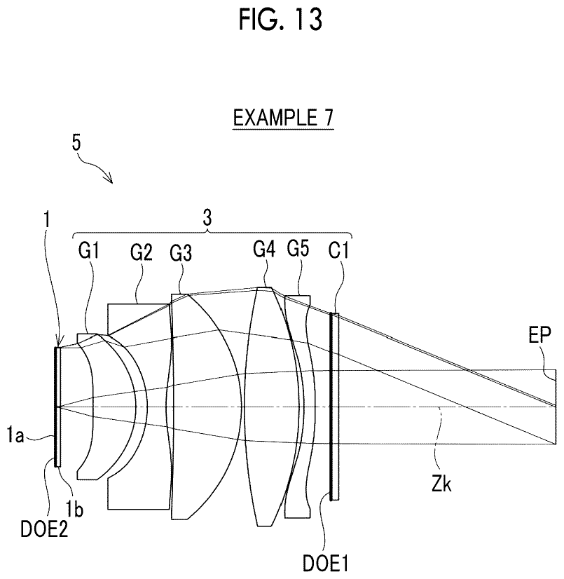

A configuration and luminous fluxes of the finder optical system 5 of Example 7 are illustrated in FIG. 13. The finder optical system 5 of Example 7 comprises, in order from the display element side to the eyepoint side, the display element 1 and the ocular optical system 3. The ocular optical system 3 includes, in order from the display element side to the eyepoint side, the lens G1 having a positive refractive power, the lens G2 having a negative refractive power, the lens G3 having a positive refractive power, the lens G4 having a positive refractive power, the lens G5 having a negative refractive power, and the cover member C1. The cover member C1 is an optical element having a shape of a parallel flat plate and not having a refractive power. The finder optical system 5 of Example 7 includes the first diffraction element DOE1 and the second diffraction element DOE2. The first diffraction element DOE1 is provided on the surface, on the display element side, of the cover member C1. The second diffraction element DOE2 is provided on the surface, on the display element side, of the cover member 1b included in the display element 1. That is, in the finder optical system 5 of Example 7, the display surface 1a of the display element 1 and the second diffraction element DOE2 are at the same position in the optical axis direction.

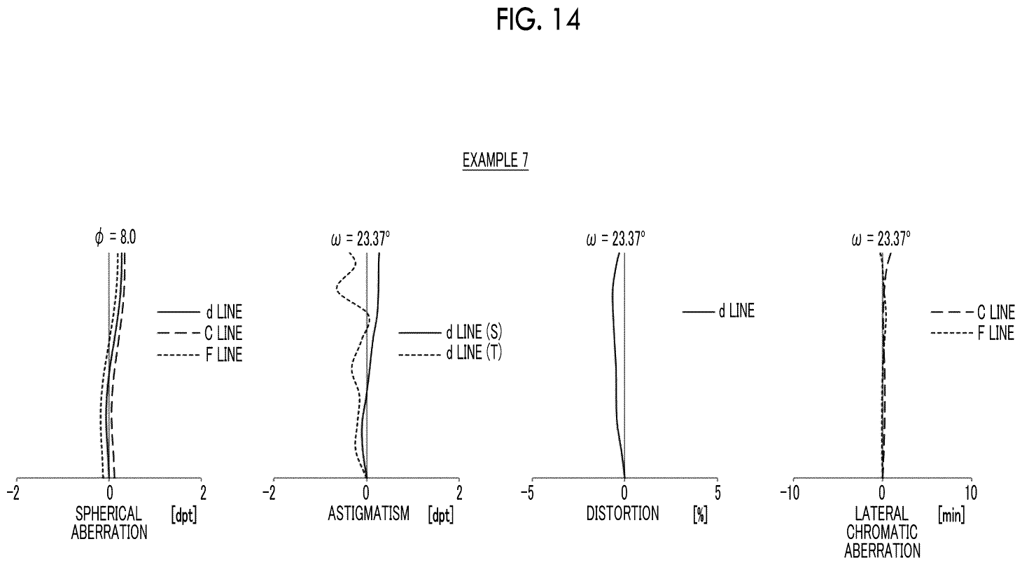

For the finder optical system 5 of Example 7, Table 24 shows basic lens data, Table 25 shows specifications, Table 26 shows an aspherical coefficient, Table 27 shows a phase difference coefficient, and FIG. 14 illustrates each aberration diagram.

TABLE 24
Example 7

| Sn | R | D | Nd | vd |
|---|---|---|---|---|
| **1 | ∞ | 0.5000 | 1.51900 | 64.90 |
| 2 | ∞ | 3.3269 | | |
| *3 | −451.8028 | 4.3768 | 1.85135 | 40.10 |
| *4 | −9.3270 | 1.1725 | | |
| *5 | −10.2753 | 1.9211 | 1.63351 | 23.63 |
| *6 | 17.8022 | 0.7577 | | |
| 7 | −337.4437 | 6.9426 | 1.77250 | 49.60 |
| 8 | −15.9370 | 0.3000 | | |
| 9 | 61.4077 | 5.5436 | 1.87070 | 40.73 |
| 10 | −30.9223 | 0.4824 | | |
| *11 | −26.8635 | 1.1625 | 1.63351 | 23.63 |
| *12 | −40.4102 | 1.6000 | | |
| **13 | ∞ | 0.8000 | 1.49023 | 57.50 |
| 14 | ∞ | 22.2000 | | |
| 15 (EP) | ∞ | | | |

TABLE 25
Example 7

| | |
|---|---|
| f | 14.55 |
| Diagonal Field of View | 46.74º |
| H | 6.35 |

TABLE 26
Example 7

| Sn | 3 | 4 | 5 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | −2.7463415E−04 | 5.7732773E−04 | 9.4207705E−04 |
| A5 | −2.6777838E−04 | −3.2670809E−04 | −6.6440676E−04 |
| A6 | 4.4599132E−05 | 3.6188329E−05 | 1.0021824E−04 |
| A7 | 6.4514056E−06 | 1.0506086E−05 | 2.1038887E−05 |
| A8 | −2.4749406E−06 | −1.6735018E−06 | −5.1243384E−06 |
| A9 | −9.2004186E−08 | −2.3159892E−07 | −3.7148654E−07 |
| A10 | 6.7555656E−08 | 4.2038813E−08 | 1.1747069E−07 |
| A11 | 6.8064247E−10 | 2.3617701E−09 | 3.6071427E−09 |
| A12 | −9.6179561E−10 | −5.1586359E−10 | −1.4388695E−09 |
| A13 | −1.4140288E−12 | −8.2435234E−12 | −1.8889240E−11 |
| A14 | 6.7738575E−12 | 2.8180956E−12 | 8.8945613E−12 |
| A15 | −3.7889536E−15 | −3.7184969E−15 | 4.1851950E−14 |
| A16 | −1.8617060E−14 | −5.0062302E−15 | −2.1620713E−14 |
| Sn | 6 | 11 | 12 |
| KA | 1.0000000E+00 | 1.0000000E+00 | 1.0000000E+00 |
| A3 | 0.0000000E+00 | 0.0000000E+00 | 0.0000000E+00 |
| A4 | −4.5198814E−04 | −3.9275102E−04 | −2.5454177E−04 |
| A5 | −1.7236759E−05 | 8.5468005E−05 | 1.1170293E−05 |
| A6 | 4.1766318E−06 | −4.3946080E−06 | 6.8855244E−06 |
| A7 | 1.7660774E−07 | −1.8025533E−06 | −6.0107117E−07 |
| A8 | −2.5978683E−08 | 2.4153901E−07 | −1.1652669E−07 |
| A9 | −8.1261618E−10 | 1.7601833E−08 | 1.2383951E−08 |
| A10 | 1.0559900E−10 | −3.0383411E−09 | 1.8033487E−09 |
| A11 | 1.9908003E−12 | −8.9660148E−11 | −1.2171402E−10 |
| A12 | −2.4516829E−13 | 1.8013067E−11 | −1.7031949E−11 |
| A13 | −2.5155111E−15 | 2.3748635E−13 | 6.0570084E−13 |
| A14 | 2.8043518E−16 | −5.2890264E−14 | 7.9842399E−14 |
| A15 | 1.2859551E−18 | −2.6800027E−16 | −1.1715677E−15 |
| A16 | −1.1446239E−19 | 6.2591337E−17 | −1.4529270E−16 |

TABLE 27
Example 7

| Sn | 1 | 13 |
|---|---|---|
| P2 | 1.8321E+02 | −1.2455E+01 |
| P4 | −2.8747E+00 | 8.3989E−02 |
| P6 | 3.0351E−02 | −8.6054E−04 |

### Example 8

A configuration and luminous fluxes of the finder optical system 5 of Example 8 are illustrated in FIG. 15. The finder optical system 5 of Example 8 comprises, in order from the display element side to the eyepoint side, the display element 1 and the ocular optical system 3. The ocular optical system 3 includes, in order from the display element side to the eyepoint side, the lens G1 having a positive refractive power, the lens G2 having a negative refractive power, the lens G3 having a positive refractive power, the lens G4 having a positive refractive power, the lens G5 having a negative refractive power, and the cover member C1. The cover member C1 is an optical element having a shape of a parallel flat plate and not having a refractive power. The finder optical system 5 of Example 8 includes the first diffraction element DOE1 and the second diffraction element DOE2. The first diffraction element DOE1 is provided on the surface, on the display element side, of the cover member C1. The second diffraction element DOE2 is provided on a surface, on the eyepoint side, of the cover member 1b included in the display element 1.

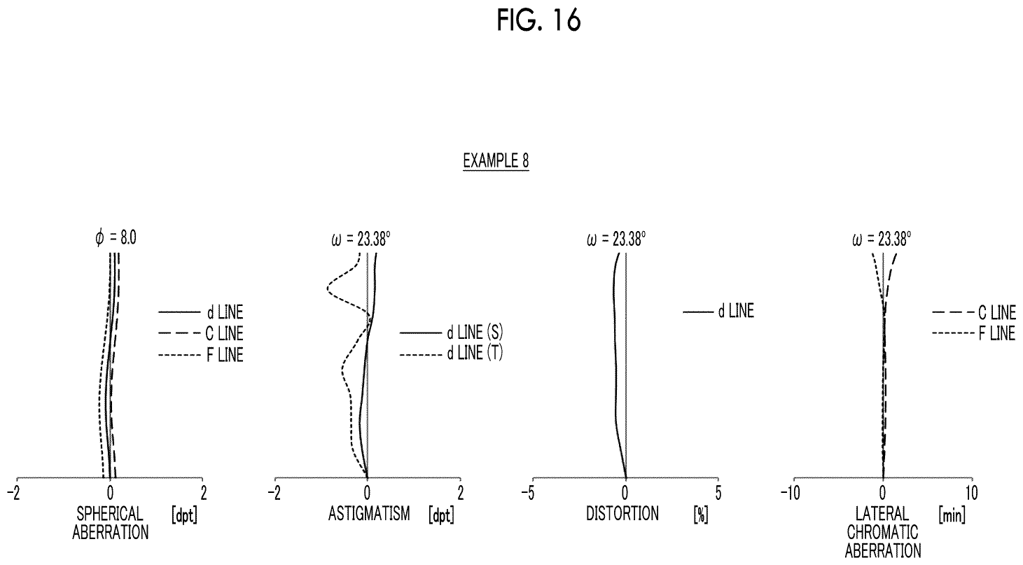

For the finder optical system 5 of Example 8, Table 28 shows basic lens data, Table 29 shows specifications, Table 30 shows an aspherical coefficient, Table 31 shows a phase difference coefficient, and FIG. 16 illustrates each aberration diagram.

TABLE 28
Example 8

| Sn | R | D | Nd | vd |
|---|---|---|---|---|
| 1 | ∞ | 0.5000 | 1.51900 | 64.90 |
| **2 | ∞ | 3.3285 | | |
| *3 | −351.2013 | 4.3859 | 1.85135 | 40.10 |
| *4 | −9.3312 | 1.1120 | | |
| *5 | −10.2891 | 1.9274 | 1.63351 | 23.63 |
| *6 | 17.8215 | 0.7606 | | |
| 7 | −323.9691 | 6.9593 | 1.77250 | 49.60 |
| 8 | −15.9476 | 0.3000 | | |
| 9 | 61.3593 | 5.5423 | 1.87070 | 40.73 |
| 10 | −30.8964 | 0.5261 | | |
| *11 | −26.8465 | 1.1625 | 1.63351 | 23.63 |
| *12 | −40.4660 | 1.6000 | | |
| **13 | ∞ | 0.8000 | 1.49023 | 57.50 |
| 14 | ∞ | 22.2000 | | |
| 15 (EP) | ∞ | | | |

TABLE 29
Example 8

| | |
|---|---|
| f | 14.45 |
| Diagonal Field of View | 46.76° |
| H | 6.35 |

TABLE 30
Example 8

| Sn | 3 | 4 | 5 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | −1.3147953E−04 | 7.1102393E−04 | 9.5836898E−04 |
| A5 | −2.6412249E−04 | −3.6416819E−04 | −6.4207292E−04 |
| A6 | 3.8940615E−05 | 3.9921384E−05 | 9.5444212E−05 |
| A7 | 6.4250419E−06 | 1.2037040E−05 | 2.0747331E−05 |
| A8 | −2.2801176E−06 | −2.0448590E−06 | −5.1314457E−06 |
| A9 | −9.2539489E−08 | −2.7637892E−07 | −3.6436028E−07 |
| A10 | 5.8151836E−08 | 5.4519552E−08 | 1.2002406E−07 |
| A11 | 7.2420615E−10 | 2.8896469E−09 | 3.5305746E−09 |
| A12 | −7.4024049E−10 | −7.0467180E−10 | −1.4892513E−09 |
| A13 | −2.3271171E−12 | −9.8055129E−12 | −1.8547198E−11 |
| A14 | 4.6011948E−12 | 4.0733273E−12 | 9.2968218E−12 |
| A15 | 1.0296749E−15 | −9.3161095E−15 | 4.1379340E−14 |
| A16 | −1.1142955E−14 | −7.7922334E−15 | −2.2787681E−14 |
| Sn | 6 | 11 | 12 |
| KA | 1.0000000E+00 | 1.0000000E+00 | 1.0000000E+00 |
| A3 | 0.0000000E+00 | 0.0000000E+00 | 0.0000000E+00 |
| A4 | −4.5125249E−04 | −3.9568871E−04 | −2.5028578E−04 |
| A5 | −1.7223747E−05 | 8.5205082E−05 | 1.1979856E−05 |
| A6 | 4.1685779E−06 | −4.2575348E−06 | 6.7385339E−06 |
| A7 | 1.7626489E−07 | −1.7964777E−06 | −6.3233364E−07 |
| A8 | −2.5933725E−08 | 2.3691237E−07 | −1.1325511E−07 |
| A9 | −8.1053712E−10 | 1.7524955E−08 | 1.2802481E−08 |
| A10 | 1.0544090E−10 | −2.9730952E−09 | 1.7531574E−09 |
| A11 | 1.9845246E−12 | −8.9124404E−11 | −1.2417911E−10 |
| A12 | −2.4484992E−13 | 1.7567671E−11 | −1.6506490E−11 |
| A13 | −2.5060542E−15 | 2.3554330E−13 | 6.1228532E−13 |
| A14 | 2.8016754E−16 | −5.1426197E−14 | 7.6597127E−14 |
| A15 | 1.2803092E−18 | −2.6511089E−16 | −1.1783930E−15 |
| A16 | −1.1446158E−19 | 6.0767174E−17 | −1.3663592E−16 |

TABLE 31
Example 8

| Sn | 2 | 13 |
|---|---|---|
| P2 | 1.9964E−06 | −1.2529E+01 |
| P4 | 9.6154E−01 | 7.3074E−02 |
| P6 | 1.1887E−02 | −8.7394E−04 |

Table 32 shows corresponding values of Conditional Expressions (1) to (4) of the finder optical systems 5 of Examples 1 to 8. The values shown in Table 32 are values based on the d line. Table 33 shows each value described in the preferable configurations of the finder optical systems 5 of Examples 1 to 8. The term “minimum spacing on optical axis” in Table 33 is a minimum spacing on the optical axis between the optical surface of the diffraction element and the optical surface of the lens disposed adjacent to the optical element on which the diffraction element is provided. The term “minimum spacing in most edge part” in Table 33 is a minimum spacing in the optical axis direction in the most edge part between the optical surface of the diffraction element and the optical surface of the lens disposed adjacent to the optical element on which the diffraction element is provided. A mm unit is used for the terms “minimum spacing on optical axis” and “minimum spacing in most edge part” in Table 33.

TABLE 32

| | Conditional | Conditional | Conditional | Conditional |
|---|---|---|---|---|
| | Expression | Expression | Expression | Expression |
| | (1) | (2) | (3) | (4) |
| | X1/TL | H/f | f/dEP | X2/TL |
| Example 1 | 0.71 | 0.44 | 0.72 | — |
| Example 2 | 0.97 | 0.44 | 0.66 | — |
| Example 3 | 0.97 | 0.44 | 0.81 | — |
| Example 4 | 0.09 | 0.43 | 0.88 | — |
| Example 5 | 0.43 | 0.44 | 0.73 | — |
| Example 6 | 0.10 | 0.46 | 0.73 | — |
| | 0.97 | | | |
| Example 7 | 0.97 | 0.44 | 0.66 | 0.00 |
| Example 8 | 0.97 | 0.44 | 0.65 | 0.03 |

TABLE 33

| | Minimum | Minimum | | | |
|---|---|---|---|---|---|
| | Spacing on | Spacing in | | | |
| | Optical Axis | Most Edge Part | νd_op | Td_op | Td_part |
| Example 1 | 0.30 | 6.76 | 40.78 | 99.8% | 94.6% |
| Example 2 | 1.50 | 2.24 | 57.50 | 98.9% | 94.6% |
| Example 3 | 1.50 | 3.05 | 57.50 | 98.9% | 96.2% |
| Example 4 | 2.00 | 2.47 | 64.90 | 99.6% | 93.5% |
| Example 5 | 1.06 | 0.58 | 64.90 | 99.6% | 94.2% |
| Example 6 | 2.10 | 2.5 | 64.90 | 99.6% | 94.0% |
| | 1.50 | 1.98 | 57.50 | 98.9% | |
| Example 7 | 1.60 | 2.17 | 57.50 | 98.9% | 94.5% |
| | 3.82 | 4.27 | 64.90 | 99.6% | |
| Example 8 | 1.60 | 2.16 | 57.50 | 98.9% | 94.1% |
| | 3.32 | 5.27 | 64.90 | 99.6% | |

The finder optical systems 5 of Examples 1 to 8 implement high optical performance by favorably correcting various aberrations while being configured to be reduced in size. In addition, in the finder optical systems 5 of Examples 1 to 8, the diagonal field of view at the full angle of view is greater than or equal to 45°, and a wide field of view is secured. Furthermore, in the finder optical systems 5 of Examples 1 to 8, the focal length of the finder optical system 5 is less than or equal to 15 mm, and a high finder magnification can be achieved.

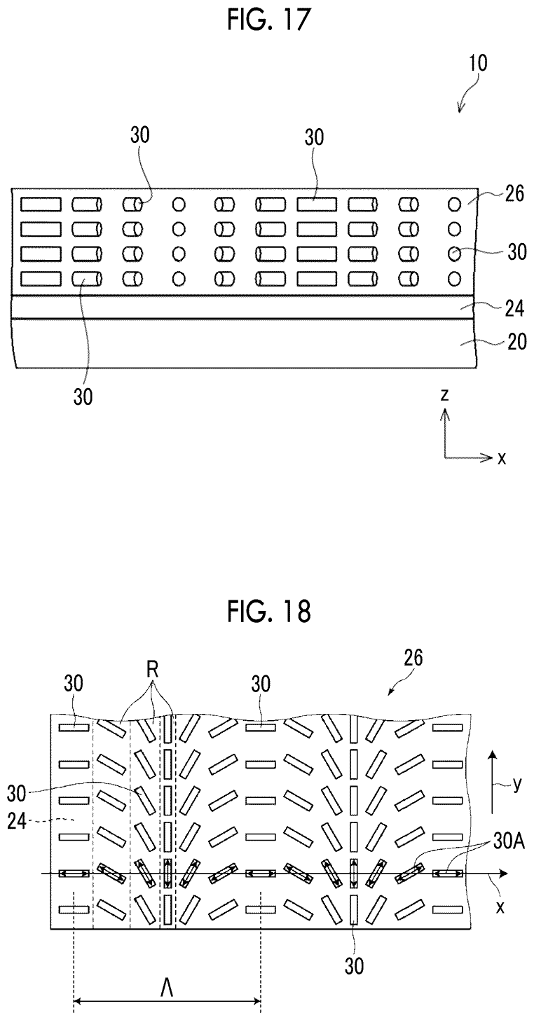

Next, a liquid crystal diffraction element according to the disclosed technology will be described with reference to FIGS. 17 to 24. In FIGS. 17 to 24, a scale of constituents is set to be different from an actual scale, as appropriate, for easy visual recognition. For example, FIG. 17 is a diagram schematically illustrating a laminated structure of a liquid crystal diffraction element 10. FIG. 18 is a plan view schematically illustrating a liquid crystal alignment pattern of the liquid crystal diffraction element 10 illustrated in FIG. 17. The liquid crystal diffraction element 10 has a sheet shape. In FIGS. 17 and 18, in an orthogonal coordinate system using an x axis, a y axis, and a z axis orthogonal to each other, a sheet surface of the liquid crystal diffraction element 10 is an xy plane, and a thickness direction is a direction of the z axis.

The liquid crystal diffraction element 10 includes a support 20, an alignment film 24, and an optically anisotropic layer 26. In the liquid crystal diffraction element 10 in FIG. 17, the alignment film 24 is formed on an outer surface of the support 20, and the optically anisotropic layer 26 is formed on an outer surface of the alignment film 24.

First, the optically anisotropic layer 26 will be described. The optically anisotropic layer 26 is formed using a composition including liquid crystal compounds 30 and has a structure in which the aligned liquid crystal compounds 30 are laminated, like an optically anisotropic layer formed using a composition including a typical liquid crystal compound. In the examples in FIGS. 17 and 18, the direction of the z axis is a lamination direction of the liquid crystal compounds 30 and is a direction perpendicular to an optical surface of the liquid crystal diffraction element 10.

In the schematic plan view of the liquid crystal diffraction element 10 illustrated in FIG. 18, only the liquid crystal compounds 30 on the outer surface of the alignment film 24 are schematically illustrated in order to clarify a configuration of the liquid crystal diffraction element 10. As illustrated in FIG. 18, the optically anisotropic layer 26 has a liquid crystal alignment pattern in which directions of optical axes 30A derived from the liquid crystal compounds 30 change while continuously rotating in one direction in a plane of the optically anisotropic layer 26. The one direction in which the optical axes 30A rotationally change is set to match a direction of the x axis in the xy plane. In the following description of the liquid crystal diffraction element 10, the one direction in which the optical axes 30A rotationally change will be described as an x direction. In the following description, a direction of the y axis will be referred to as a y direction, and the direction of the z axis will be referred to as a z direction.

The optical axes 30A derived from the liquid crystal compounds 30 are so-called slow axes that are axes of the highest refractive index in the liquid crystal compounds 30. As illustrated in FIG. 17, in a case where the liquid crystal compounds 30 are rod-shaped liquid crystal compounds, the optical axes 30A are present along major axis directions of rod shapes. In the following description, the optical axes 30A derived from the liquid crystal compounds 30 will be referred to as the optical axes 30A of the liquid crystal compounds 30 or simply the optical axes 30A.

Specifically, the fact that the direction of the optical axis 30A changes while continuously rotating in the x direction means that angles between the optical axes 30A of the liquid crystal compounds 30 arranged along the x direction and the x direction vary depending on a position in the x direction, and the angles between the optical axes 30A and the x direction gradually change from θ to θ+180° or θ−180° along the x direction. The expression “the angles gradually change” may indicate that the angles change at certain angular spacings or change continuously. A difference between the angles of the optical axes 30A of the liquid crystal compounds 30 adjacent to each other in the x direction is preferably less than or equal to 45°, more preferably less than or equal to 15°, and further preferably a smaller angle.

Meanwhile, in the y direction orthogonal to the x direction, the liquid crystal compounds 30 having equal directions of the optical axes 30A are arranged at equal spacings. In other words, in the liquid crystal compounds 30 forming the optically anisotropic layer 26, the liquid crystal compounds 30 arranged in the y direction have equal angles between the optical axes 30A and the x direction.

In the liquid crystal diffraction element 10 having such a liquid crystal alignment pattern of the liquid crystal compounds 30, a length (distance) in which the optical axes 30A of the liquid crystal compounds 30 rotate by 1800 in the x direction will be referred to as a single period A in the liquid crystal alignment pattern, a single period Λ of the liquid crystal alignment pattern, or simply a single period Λ. In other words, a length of a single period in the liquid crystal alignment pattern is defined as a distance in which the angles between the optical axes 30A of the liquid crystal compounds 30 and the x direction changes from θ to θ+180°. Specifically, as illustrated in FIG. 18, the single period Λ is a distance between centers, in the x direction, of two liquid crystal compounds 30 of which the directions of the optical axes 30A match the x direction. In the liquid crystal diffraction element 10, the liquid crystal alignment pattern of the optically anisotropic layer 26 is a pattern in which liquid crystal alignment of the single period Λ is repeated in the x direction.

As described above, in the optically anisotropic layer 26, the liquid crystal compounds 30 arranged in the y direction have equal angles between their optical axes 30A and the x direction. Regions in which the liquid crystal compounds 30 having equal angles between the optical axes 30A and the x direction are arranged in the y direction will be referred to as regions R.

In this case, a value of in-plane retardation Re in each region R is preferably a half wavelength of light (hereinafter, referred to as target light) to be diffracted by the liquid crystal diffraction element 10. That is, in a case where the wavelength of the target light is denoted by λ, the in-plane retardation Re is preferably λ/2. The reason for this is that, as the value of the in-plane retardation is closer to the half wavelength of the target light, higher diffraction efficiency can be obtained in diffraction of the target light.

The in-plane retardation Re is calculated as a product of a refractive index difference Δn caused by refractivity anisotropy of the regions R and a thickness of the optically anisotropic layer 26. The refractive index difference caused by the refractivity anisotropy of the regions R is a refractive index difference defined as a difference between refractive indices in directions of the slow axes in planes of the regions R and refractive indices in directions orthogonal to the directions of the slow axes. That is, the refractive index difference Δn caused by the refractivity anisotropy of the regions R is equal to a difference between refractive indices of the liquid crystal compounds 30 in the directions of the optical axes 30A and refractive indices of the liquid crystal compounds 30 in directions perpendicular to the optical axes 30A in the planes of the regions R. That is, the refractive index difference Δn depends on the liquid crystal compounds 30, and the in-plane retardation Re of each region R is substantially equal.

In a case where in-plane retardation in the wavelength λ is denoted by Re(λ), a refractive index difference caused by the refractivity anisotropy in the wavelength λ is denoted by Δn_{λ}, and the thickness of the optically anisotropic layer 26 is denoted by d, the in-plane retardation Re(λ) of the optically anisotropic layer 26 with respect to an incidence ray having a wavelength of λ nm is represented by

$$Re ( λ ) = Δ {n}_{λ} \times d .$$

In this case, the in-plane retardation Re(λ) of the optically anisotropic layer 26 is preferably within a range defined by the following expression and can be appropriately set.

0.7×(λ/2) nm≤Δnₓ×d≤1.3×(λ/2) nm

For example, Re(λ) can be obtained by performing measurement in the wavelength λ using AxoScan (manufactured by Axometrics, Inc.). By inputting an average refractive index and a film thickness into AxoScan, slow axis direction (°) Re(λ)=R0(λ) is calculated. The film thickness is in units of m. In a case where refractive indices in the x direction, the y direction, and the z direction are denoted by nx, ny, and nz, respectively, the average refractive index is represented by ((nx+ny+nz)/3). R0(λ) is displayed as a numerical value calculated by AxoScan and means Re(λ).

In a case where the value of the in-plane retardation is set to λ/2, the optically anisotropic layer 26 functions as a general ½ waveplate. That is, in a case where the value of the in-plane retardation is set to λ/2, the optically anisotropic layer 26 has a function of imparting a phase difference of a half wavelength, that is, 180°, to two linearly polarized light components that are orthogonal to each other and that are included in the light incident on the optically anisotropic layer 26. While the optically anisotropic layer 26 functions as a ½ waveplate, the present disclosure also includes an aspect in which a laminate comprising the support 20 and the alignment film 24 in an integrated manner functions as a ½ waveplate.

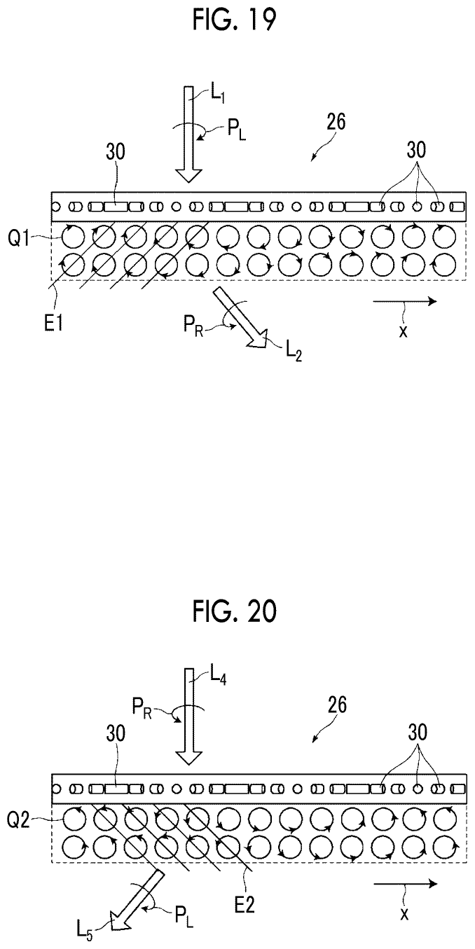

In a case where circularly polarized light is incident on the above optically anisotropic layer 26, a traveling direction of the light is changed by diffraction, that is, the light is polarized by diffraction, and a revolution direction of the circularly polarized light is converted. This action is conceptually illustrated in FIGS. 19 and 20 using the optically anisotropic layer 26 as an example. As described above, the optically anisotropic layer 26 has a structure in which the aligned liquid crystal compounds 30 are laminated. However, for easy understanding, FIGS. 19 and 20 are simplified to illustrate only the liquid crystal compounds 30 on the outer surface of the alignment film 24 in the optically anisotropic layer 26.

The in-plane retardation of the optically anisotropic layer 26 in FIGS. 19 and 20 is assumed to be λ/2. In this case, as illustrated in FIG. 19, in a case where an incidence ray L₁ that is levorotatory circularly polarized light P_{L} is incident on the optically anisotropic layer 26, the incidence ray L₁ passes through the optically anisotropic layer 26, and a phase difference of 180° is imparted to the incidence ray L₁. Accordingly, a transmitted ray L₂ is converted into dextrorotatory circularly polarized light P_{R}.

While the incidence ray L₁ is passing through the optically anisotropic layer 26, an absolute phase of the incidence ray L₁ changes in accordance with the direction of the optical axis 30A of each liquid crystal compound 30. At this point, since the directions of the optical axes 30A change while rotating along the x direction, an amount of change in the absolute phase of the incidence ray L₁ varies depending on the directions of the optical axes 30A. Furthermore, since the liquid crystal alignment pattern formed in the optically anisotropic layer 26 is a periodic pattern in the x direction, a periodic absolute phase Q1 in the x direction corresponding to the direction of each optical axis 30A is imparted to the incidence ray L₁ that has passed through the optically anisotropic layer 26, as illustrated in FIG. 19. Accordingly, an equiphase plane E1 inclined in a direction opposite to the x direction is formed.

Thus, the transmitted ray L₂ is refracted to be inclined in a direction perpendicular to the equiphase plane E1 and travels in a direction different from a traveling direction of the incidence ray L₁. The incidence ray L₁ of the levorotatory circularly polarized light P_{L} is converted into the transmitted ray L₂ of the dextrorotatory circularly polarized light P_{R} inclined in the x direction by a predetermined angle with respect to an incidence direction.

Meanwhile, as conceptually illustrated in FIG. 20, in a case where an incidence ray L₄ of the dextrorotatory circularly polarized light P_{R} is incident on the optically anisotropic layer 26 having the same in-plane retardation, the incidence ray L₄ passes through the optically anisotropic layer 26, and a phase difference of 180° is imparted to the incidence ray L₄. Accordingly, the incidence ray L₄ is converted into a transmitted ray L₅ of the levorotatory circularly polarized light P_{L}.

While the incidence ray L₄ is passing through the optically anisotropic layer 26, an absolute phase of the incidence ray L₄ changes in accordance with the direction of the optical axis 30A of each liquid crystal compound 30. At this point, since the directions of the optical axes 30A change while rotating along the x direction, an amount of change in the absolute phase of the incidence ray L₄ varies depending on the directions of the optical axes 30A. Furthermore, since the liquid crystal alignment pattern formed in the optically anisotropic layer 26 is a periodic pattern in the x direction, a periodic absolute phase Q2 in the x direction corresponding to the direction of each optical axis 30A is imparted to the incidence ray L₄ that has passed through the optically anisotropic layer 26, as illustrated in FIG. 20.

Since the incidence ray L₄ in FIG. 20 is the dextrorotatory circularly polarized light P_{R}, the periodic absolute phase Q2 in the x direction corresponding to the directions of the optical axes 30A is opposite to that in the case of the incidence ray L₁ that is the levorotatory circularly polarized light P_{L} in FIG. 19. Consequently, an equiphase plane E2 inclined in the x direction contrary to that in the case of the incidence ray L₁ is formed in the incidence ray L₄.

Thus, the transmitted ray L₅ is refracted to be inclined in a direction perpendicular to the equiphase plane E2 and travels in a direction different from a traveling direction of the incidence ray L₄. The incidence ray L₄ of the dextrorotatory circularly polarized light P_{R} is converted into the transmitted ray L₅ of the levorotatory circularly polarized light P_{L} inclined in a direction opposite to the x direction by a predetermined angle with respect to an incidence direction.

By changing the single period Λ of the liquid crystal alignment pattern formed in the optically anisotropic layer 26, angles of polarization (diffraction angles) of the transmitted ray L₂ and the transmitted ray L₅ can be adjusted. Specifically, as the single period Λ of the liquid crystal alignment pattern is shorter, rays that have passed through the liquid crystal compounds 30 adjacent to each other interfere with each other stronger. Thus, the transmitted ray L₂ and the transmitted ray L₅ can be significantly polarized. Furthermore, by reversing rotation directions of the optical axes 30A of the liquid crystal compounds 30 that rotate along the x direction, a direction of polarization of the transmitted ray can be reversed.

While an example in which the liquid crystal compounds 30 are rod-shaped liquid crystal compounds has been illustrated in the above example, a type of liquid crystal compound included in the optically anisotropic layer is not particularly limited and may be a disk-shaped liquid crystal compound. Two or more types of rod-shaped liquid crystal compounds, two or more types of disk-shaped liquid crystal compounds, or a mixture of the rod-shaped liquid crystal compound and the disk-shaped liquid crystal compound may also be used. The optically anisotropic layer may further contain other components such as a leveling agent, an alignment control agent, a polymerization initiator, and an alignment assistant.

Azomethine compounds, azoxy compounds, cyanobiphenyl compounds, cyanophenyl ester compounds, benzoic acid ester compounds, cyclohexanecarboxylic acid phenyl ester compounds, cyanophenylcyclohexane compounds, cyano-substituted phenylpyrimidine compounds, alkoxy-substituted phenylpyrimidine compounds, phenyldioxane compounds, tolan compounds, and alkenylcyclohexylbenzonitrile compounds are preferably used as the rod-shaped liquid crystal compounds. Not only the above low molecular weight liquid crystal molecules but also high molecular weight liquid crystal molecules can be used.

For example, disk-shaped liquid crystal compounds according to JP2007-108732A and JP2010-244038A can be preferably used. In a case where the disk-shaped liquid crystal compound is used in the optically anisotropic layer, the liquid crystal compound stands in the thickness direction in the optically anisotropic layer, and the optical axis derived from the liquid crystal compound is defined as a so-called slow axis that is an axis perpendicular to a disk plane.

The optically anisotropic layer desirably has a wide bandwidth with respect to the wavelength of the incidence ray and is preferably configured using a liquid crystal material having anomalous dispersion of a birefringence index. The optically anisotropic layer is preferably provided with a substantially wide bandwidth with respect to the wavelength of the incidence ray by providing a twist component to the liquid crystal composition or by laminating different retardation layers. For example, JP2014-089476A discloses a method of implementing a patterned ½ waveplate having a wide bandwidth by laminating two liquid crystal layers having different twist directions in the optically anisotropic layer, and this method may be used.

Next, the support 20 will be described. The support 20 supports the alignment film 24 and the optically anisotropic layer 26. Any of various objects having a sheet shape, for example, a film or an object having a plate shape that can support the alignment film 24 and the optically anisotropic layer 26 can be used as the support 20. The support 20 is preferably a transparent support, and examples of the support 20 include a polyacrylic-based resin film such as polymethyl methacrylate, a cellulose-based resin film such as cellulose triacetate, a cycloolefin polymer-based film (for example, ARTON (registered trademark) manufactured by JSR Corporation and ZEONOR (registered trademark) manufactured by Zeon Corporation), polyethylene terephthalate (PET), polycarbonate, and polyvinyl chloride. The support 20 is not limited to a flexible film and may be a non-flexible substrate such as a glass substrate. The support 20 may have multiple layers. Examples of the support having multiple layers include a support including any of the above supports as a substrate, in which another layer is provided on an outer surface of the substrate.

A thickness of the support 20 is not limited and may be appropriately set to a thickness with which the alignment film 24 and the optically anisotropic layer 26 can be held, in accordance with a purpose of the liquid crystal diffraction element 10 and a forming material and the like of the support 20. The thickness of the support 20 is preferably 1 to 1000 μm, more preferably 3 to 250 μm, and further preferably 5 to 150 μm.

Next, the alignment film 24 will be described. The alignment film 24 is a film for aligning liquid crystal compounds 30 with a predetermined liquid crystal alignment pattern while forming the optically anisotropic layer 26. As described above, the optically anisotropic layer 26 of the liquid crystal diffraction element 10 has the liquid crystal alignment pattern in which the directions of the optical axes 30A change while continuously rotating along the one direction in plane. Accordingly, the alignment film 24 is formed such that the optically anisotropic layer 26 can form the liquid crystal alignment pattern.

Various well-known alignment films can be used as the alignment film 24. Examples of the alignment film include a rubbing treatment film consisting of an organic compound such as a polymer, an oblique vapor deposition film of an inorganic compound, a film having a microgroove, and a film obtained by accumulating a Langmuir-Blodgett (LB) film of an organic compound such as ω-tricosanoic acid, methyldioctadecylammonium chloride, and methyl stearate using the Langmuir-Blodgett method.

In the liquid crystal diffraction element 10, a so-called photo-alignment film obtained by irradiating a material having photo-aligning properties with polarized light or non-polarized light to form an alignment film is suitably used as the alignment film 24. That is, in the liquid crystal diffraction element 10, a photo-alignment film formed by coating the support 20 with a photo-alignment material is suitably used as the alignment film 24. The photo-alignment film can be irradiated with the polarized light in a perpendicular direction or an oblique direction, and the photo-alignment film can be irradiated with the non-polarized light in an oblique direction.

A thickness of the alignment film 24 is not limited, and a thickness with which a necessary orientation function can be obtained may be appropriately set in accordance with a material forming the alignment film 24. The thickness of the alignment film 24 is preferably 0.01 to 5 μm and more preferably 0.05 to 2 μm.

A method of forming the alignment film 24 is not limited, and various well-known methods corresponding to the material forming the alignment film 24 can be used. Examples include a method of forming the alignment pattern by coating the outer surface of the support 20 with the alignment film and drying the alignment film, and then exposing the alignment film to laser light.

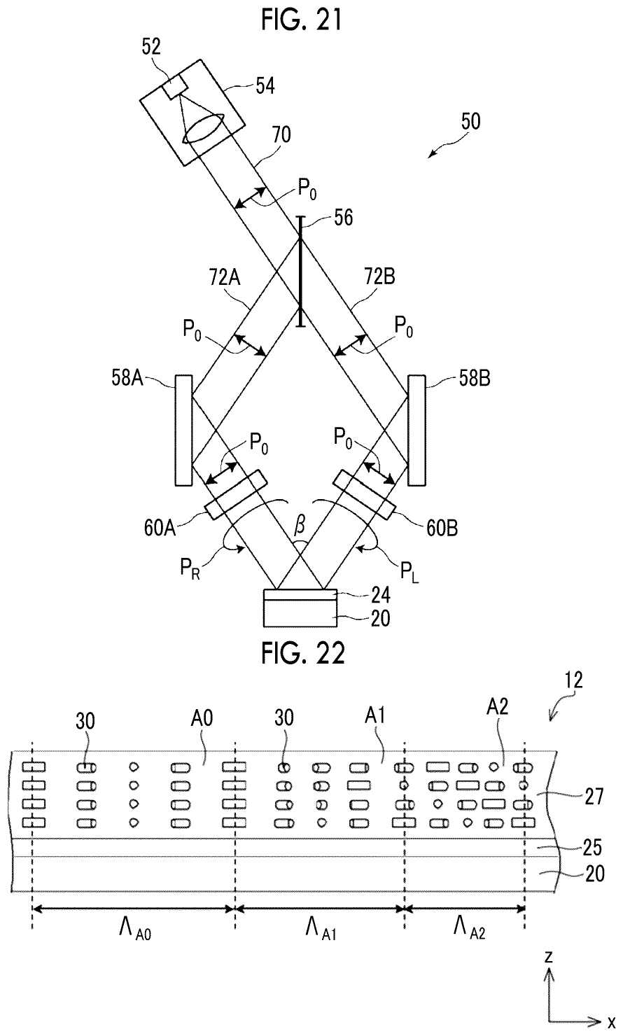

FIG. 21 conceptually illustrates an example of an exposure device that forms the alignment pattern by exposing the alignment film. In the example illustrated in FIG. 21, for example, exposure of the alignment film 24 of the liquid crystal diffraction element 10 is illustrated.

An exposure device 50 illustrated in FIG. 21 comprises a light source 54 comprising a laser 52, a beam splitter 56 that separates laser light 70 emitted from the laser 52 into two rays 72A and 72B, a mirror 58A and a mirror 58B disposed on optical paths of the two separated rays 72A and 72B, respectively, and a ¼ waveplate 60A and a ¼ waveplate 60B. The light source 54 emits linearly polarized light P₀. The ¼ waveplate 60A and the ¼ waveplate 60B comprise optical axes orthogonal to each other. The ¼ waveplate 60A converts the linearly polarized light P₀ (ray 72A) into the dextrorotatory circularly polarized light P_{R}, and the ¼ waveplate 60B converts the linearly polarized light P₀ (ray 72B) into the levorotatory circularly polarized light P_{L}.

The support 20 including the alignment film 24 before forming the alignment pattern is disposed in an exposed portion, and the two rays 72A and 72B interfere with each other by intersecting with each other on the alignment film 24. The alignment film 24 is exposed by being irradiated with interference light. The interference causes a polarization state of the light with which the alignment film 24 is irradiated to periodically change in a shape of interference fringes. Accordingly, an alignment pattern in which an alignment state periodically changes can be obtained in the alignment film 24.

In the exposure device 50, the period of the alignment pattern can be adjusted by changing an intersecting angle β between the two rays 72A and 72B. That is, in the exposure device 50, the single period Λ in the one direction in which the optical axes 30A rotate in the alignment pattern in which the optical axes 30A derived from the liquid crystal compounds 30 continuously rotate along the one direction can be adjusted by adjusting the intersecting angle β.

By forming the optically anisotropic layer 26 on the alignment film 24 having such an alignment pattern in which the alignment state periodically changes, the optically anisotropic layer 26 having the liquid crystal alignment pattern in which the optical axes 30A derived from the liquid crystal compounds 30 continuously rotate along the one direction can be formed. In addition, by rotating each of the optical axes of the ¼ waveplate 60A and the ¼ waveplate 60B by 90°, the rotation directions of the optical axes 30A can be reversed.

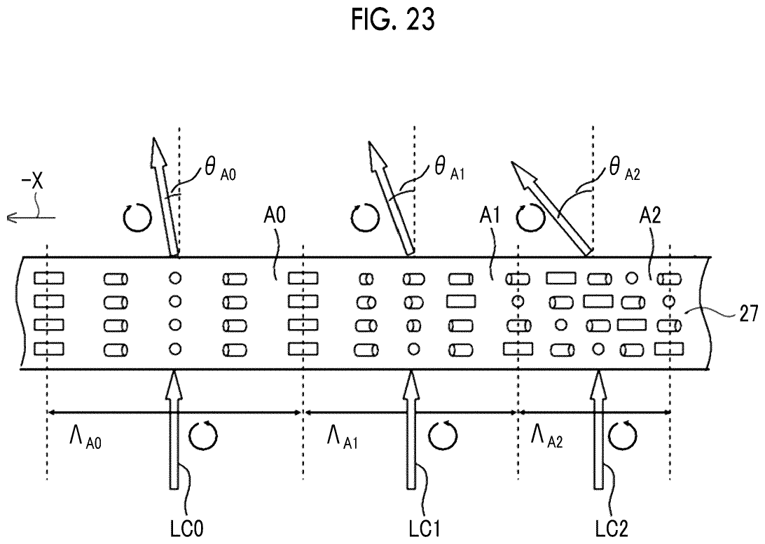

Next, a liquid crystal diffraction element 12 of another example according to the disclosed technology will be described with reference to FIGS. 22 and 23. FIG. 22 is a diagram schematically illustrating a laminated structure of the liquid crystal diffraction element 12. The liquid crystal diffraction element 12 includes the support 20, an alignment film 25, and an optically anisotropic layer 27. The alignment film 25 is formed on the outer surface of the support 20, and the optically anisotropic layer 27 is formed on an outer surface of the alignment film 25. The liquid crystal diffraction element 12 has a sheet shape like the liquid crystal diffraction element 10. In FIG. 22, in the orthogonal coordinate system using the x axis, the y axis, and the z axis orthogonal to each other, a sheet surface of the liquid crystal diffraction element 12 is the xy plane, and the thickness direction is the z direction.

The optically anisotropic layer 27 is formed using a composition including the liquid crystal compounds 30 and has a structure in which the aligned liquid crystal compounds 30 are laminated. The optically anisotropic layer 27 has a liquid crystal alignment pattern in which the directions of the optical axes 30A derived from the liquid crystal compounds 30 change while continuously rotating in one direction in a plane of the optically anisotropic layer 27. The one direction in which the optical axes 30A rotationally change in the liquid crystal diffraction element 12 is the x direction. In the example in FIG. 22, the z direction is the lamination direction of the liquid crystal compounds 30 and is a direction perpendicular to an optical surface of the liquid crystal diffraction element 12.

The optically anisotropic layer 27 is formed such that different regions in plane have different single periods Λ of the liquid crystal alignment pattern. In the part illustrated in FIG. 22, the optically anisotropic layer 27 has three regions A0, A1, and A2 from the left side in FIG. 22, and each region has a different single period Λ of the liquid crystal alignment pattern. Specifically, a single period Λ_{A2} of the liquid crystal alignment pattern of the region A2 is shorter than a single period Λ_{A1} of the liquid crystal alignment pattern of the region A1, and the single period Λ_{A1} of the liquid crystal alignment pattern of the region A1 is shorter than a single period Λ_{A0} of the liquid crystal alignment pattern of the region A0. That is, Λ_{A0}>Λ_{A1}>Λ_{A2} is established.

The region A1 and the region A2 have a structure (hereinafter, referred to as a twist structure) in which the optical axes rotate in a twisted manner in the thickness direction (z direction) of the optically anisotropic layer 27. A twist angle of the region A1 in the thickness direction is less than a twist angle of the region A2 in the thickness direction. The region A0 is a region not having the twist structure. That is, a twist angle of the region A0 is 0°. The twist angle is a twist angle in the entire thickness direction.

As described above, the optically anisotropic layer 27 has the liquid crystal alignment pattern in which the directions of the optical axes derived from the liquid crystal compounds 30 rotate in the one direction, regions having different twist angles of rotation in plane, and furthermore, regions in which the optical axes rotate in a twisted manner in the thickness direction of the optically anisotropic layer 27. The alignment film 25 is formed such that the optically anisotropic layer 27 has the above liquid crystal alignment pattern.

An action of the optically anisotropic layer 27 having the above configuration will be described with reference to FIG. 23. In the liquid crystal diffraction element 12, basically only the optically anisotropic layer 27 exhibits an optical action. Thus, FIG. 23 is simplified to illustrate only the optically anisotropic layer 27 in order to clarify the configuration and an effect of the action.

As illustrated in FIG. 23, in a case where levorotatory circularly polarized light LC0 is incident on the region A0 in the plane of the optically anisotropic layer 27, the levorotatory circularly polarized light LC0 is polarized by an angle θ_{A0} in the −x direction with respect to the incidence direction and transmitted, as described above. The −x direction in FIG. 23 is a direction opposite to the x direction in FIG. 22. Similarly, in a case where levorotatory circularly polarized light LC1 is incident on the region A1 in the plane of the optically anisotropic layer 27, the levorotatory circularly polarized light LC1 is polarized by an angle θ_{A1} in the −x direction with respect to the incidence direction and transmitted. Similarly, in a case where levorotatory circularly polarized light LC2 is incident on the region A2 in the plane of the optically anisotropic layer 27, the levorotatory circularly polarized light LC2 is polarized by an angle θ_{A2} in the −x direction with respect to the incidence direction and transmitted.

As described above, the optically anisotropic layer that is formed using the composition including the liquid crystal compounds 30 and that has the liquid crystal alignment pattern in which the directions of the optical axes 30A rotate along the x direction polarizes circularly polarized light. However, as the single period Λ of the liquid crystal alignment pattern is shorter, the angle of polarization (diffraction angle) is larger. As described above, a magnitude relationship of the single period of the liquid crystal alignment pattern in each of the region A0, the region A1, and the region A2 is represented by Λ_{A0}>Λ_{A1}>Λ_{A2}. Thus, a magnitude relationship of the angle of polarization of the transmitted ray with respect to the incidence ray in each of the region A0, the region A1, and the region A2 is represented by θ_{A0}<θ_{A1}<θ_{A2}.

In diffraction of light in the optically anisotropic layer having the liquid crystal alignment pattern in which the directions of the optical axes of the liquid crystal compounds 30 change while continuously rotating in plane, as the diffraction angle is increased, the diffraction efficiency is decreased, that is, intensity of diffracted light is decreased. Thus, in a case where the optically anisotropic layer is configured to have regions having different single periods Λ of the liquid crystal alignment pattern, the diffraction angle varies depending on an incidence position of light. Thus, alight quantity of the diffracted light varies depending on the incidence position in plane. That is, a region in which brightness of the light transmitted through the optically anisotropic layer is decreased occurs depending on the incidence position in plane.

Meanwhile, the optically anisotropic layer 27 illustrated in FIGS. 22 and 23 has a region having twisted rotation in the thickness direction and has regions having different magnitudes of the twist angle in the thickness direction. In the examples illustrated in FIGS. 22 and 23, the twist angle of the region A2 in the thickness direction is larger than the twist angle of the region A1 in the thickness direction. The region A0 does not have the twist structure in the thickness direction. A region having the twisted structure can improve the diffraction efficiency compared to a region not having the twisted structure. Thus, in the optically anisotropic layer 27, a decrease in the diffraction efficiency of the polarized light can be suppressed.

In the example illustrated in FIG. 23, a decrease in the light quantity of the light polarized in the region A1 and the region A2 can be suppressed by providing the twist structure in the region A1 and the region A2 having a larger diffraction angle than the region A0. In addition, a decrease in the light quantity of the light polarized in the region A2 can be suppressed by setting the twist angle of the twist structure of the region A2 having a larger diffraction angle than the region A1 to be larger than that of the region A1.

That is, in the optically anisotropic layer 27, a direction of a permutation of lengths of the single period Λ in the liquid crystal alignment pattern is configured to be different from a direction of a permutation of magnitudes of the twist angle in the thickness direction. More specifically, in the optically anisotropic layer 27, since the twist angle in the thickness direction is larger as the single period Λ of the liquid crystal alignment pattern in the region is shorter, brightness of the transmitted ray can be increased. Accordingly, even in a case where the optically anisotropic layer 27 is configured to have regions having different single periods Λ of the liquid crystal alignment pattern, the light quantity of the transmitted light can be uniform regardless of the incidence position in plane.

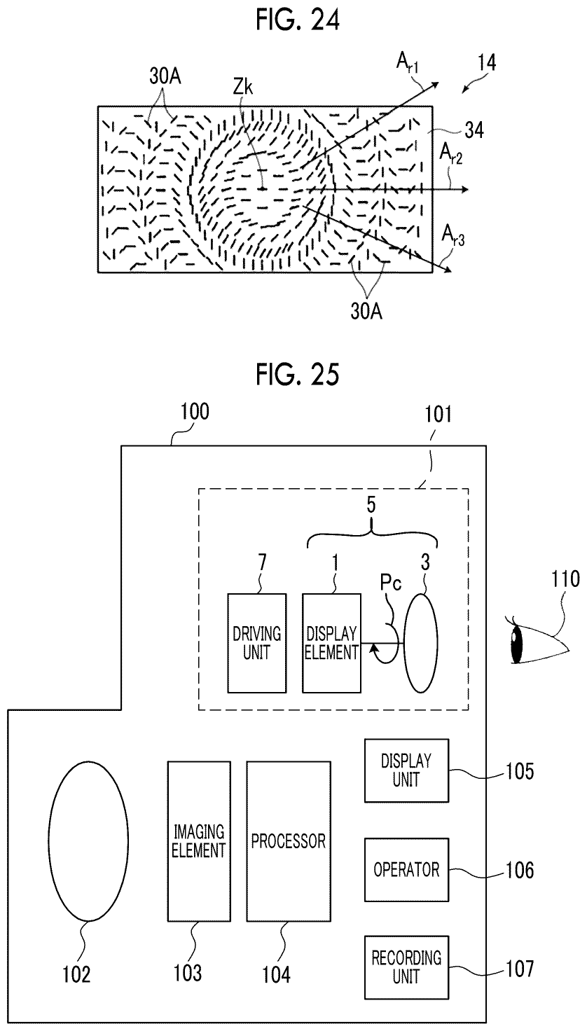

Next, a liquid crystal diffraction element 14 according to one embodiment of the present disclosure will be described with reference to FIG. 24. FIG. 24 is a plan view schematically illustrating a liquid crystal alignment pattern of the liquid crystal diffraction element 14 according to one embodiment of the present disclosure. Like the liquid crystal diffraction element 12, the liquid crystal diffraction element 14 has a sheet shape and has a configuration in which an alignment film (not illustrated) is formed on an outer surface of a support (not illustrated), and an optically anisotropic layer 34 is formed on an outer surface of the alignment film. Like the liquid crystal diffraction element 12, the optically anisotropic layer 34 is formed using a composition including liquid crystal compounds and has a structure in which the aligned liquid crystal compounds are laminated. A sheet surface is a surface parallel to the page of FIG. 24, and a lamination direction is a direction perpendicular to the page of FIG. 24. For easy understanding, FIG. 24 is simplified to illustrate the liquid crystal alignment pattern of the optically anisotropic layer 34 using the optical axes 30A of the liquid crystal compounds.

In the optically anisotropic layer 26 in FIG. 18 and the optically anisotropic layer 27 in FIG. 22, the optical axes 30A continuously rotate along only the x direction in plane. Compared to these, the optically anisotropic layer 34 in FIG. 24 has a significantly different liquid crystal alignment pattern in which the one direction in which the directions of the optical axes 30A change while continuously rotating is radially provided. In addition, in the optically anisotropic layer 34, regions having the same direction of the optical axes 30A are concentrically provided. In the example in FIG. 24, a center of concentric circles is a center of the optically anisotropic layer 34, and an axis in the thickness direction passing through the center is the optical axis Zk. The optically anisotropic layer 34 has a periodic structure in a direction perpendicular to the optical axis Zk and has a concentric structure centered on the optical axis Zk, more specifically, a concentric liquid crystal alignment pattern centered on the optical axis Zk.

In the optically anisotropic layer 34, the directions of the optical axes 30A change while continuously rotating along multiple outward directions from the center of the optically anisotropic layer 34, for example, a direction indicated by arrow Ar₁, a direction indicated by arrow Ar₂, a direction indicated by arrow Ar₃, . . . . An absolute phase of circularly polarized light incident on the optically anisotropic layer 34 having this liquid crystal alignment pattern changes in each of individual local regions having different directions of the optical axes 30A of the liquid crystal compounds. An amount of change in each absolute phase varies depending on the directions of the optical axes 30A of the liquid crystal compounds on which the circularly polarized light is incident.

The optically anisotropic layer 34 having the concentric liquid crystal alignment pattern, that is, the liquid crystal alignment pattern in which the optical axes 30A radially change while continuously rotating can allow transmission of the incidence ray as converging light or diverging light in accordance with the rotation directions of the optical axes 30A of the liquid crystal compounds and the revolution direction of the incident circularly polarized light. That is, for example, by providing the concentric liquid crystal alignment pattern in the optically anisotropic layer 34, the liquid crystal diffraction element 14 exhibits the same function as a positive lens or a negative lens.

In a case where the liquid crystal diffraction element 14 is caused to act in the same manner as the positive lens or the negative lens, the following expression is preferably satisfied.

$$Φ ( r ) = ( π / λ ) [ {( {r}^{2} + {fa}^{2} )}^{1 / 2} - fa ]$$

r denotes a distance from the center of the concentric circles (in FIG. 24, the optical axis Zk) and is represented by r=(x²+y²)^{1/2}. x and y denote positions in plane, and (x, y)=(0, 0) denotes the center of the concentric circles. Φ(r) denotes angles of the optical axes 30A at the distance r from the center of the concentric circles, λ denotes a wavelength, and fa denotes a target focal length.

As described above, the angle of polarization of light with respect to the incidence direction is larger as the single period Λ in the liquid crystal alignment pattern is shorter. Accordingly, in a case where the optically anisotropic layer 34 is configured to allow transmission of the incidence ray as the converging light, the optically anisotropic layer 34 can be caused to act in the same manner as the positive lens in which converging power of light is increased from the optical axis Zk to an edge part, by gradually shortening the single period Λ in the liquid crystal alignment pattern in an outward direction of the one direction in which the optical axes 30A continuously rotate, from the center of the optically anisotropic layer 34.

The configuration in which the optically anisotropic layer 34 allows transmission of the incidence ray as the converging light can be changed to a configuration in which the optically anisotropic layer 34 allows transmission of the incidence ray as the diverging light, by reversing the direction in which the optical axes 30A continuously rotate. Alternatively, the configuration in which the optically anisotropic layer 34 allows transmission of the incidence ray as the converging light can be changed to the configuration in which the optically anisotropic layer 34 allows transmission of the incidence ray as the diverging light, by reversing the revolution direction of the circularly polarized light incident on the optically anisotropic layer 34.

In a case where the optically anisotropic layer 34 is configured to allow transmission of the incidence ray as the diverging light, the optically anisotropic layer 34 can be caused to act in the same manner as the negative lens in which diverging power of light is increased from the optical axis Zk to an edge part, by gradually shortening the single period Λ in the liquid crystal alignment pattern outward in the one direction in which the optical axes 30A continuously rotate, from the center of the optically anisotropic layer 34.

A case where the single period Λ of the periodic structure of the optically anisotropic layer 34 is configured to be gradually decreased from the optical axis Zk to the edge part is effective because aberrations can be more strongly corrected in the edge part in which a significant chromatic aberration is likely to occur. In addition, such a configuration has good manufacturability and thus, achieves an advantage in achieving reduction in cost. The single period Λ of the periodic structure in the most edge part of the optically anisotropic layer 34 is preferably greater than or equal to 0.5 μm. Doing so achieves a configuration having good manufacturability and thus, achieves an advantage in reduction in cost.

In a case where the optically anisotropic layer 34 is configured to have regions having different single periods Λ of the liquid crystal alignment pattern, the twist structure in the thickness direction as illustrated in FIG. 22 is preferably provided in order to improve uniformity of the transmitted ray. In this case, the twist angle in the thickness direction is preferably appropriately set in accordance with the single period Λ of the liquid crystal alignment pattern in plane and a desired light quantity distribution in plane.

While the liquid crystal diffraction element has been described with reference to the drawings, the liquid crystal diffraction element is not limited to the above example, and various modifications can be made without departing from the gist of the disclosed technology. For example, while the liquid crystal diffraction element of the above example includes the support and the alignment film, the liquid crystal diffraction element may be configured with only the alignment film and the optically anisotropic layer by peeling off the support, or the liquid crystal diffraction element may be configured with only the optically anisotropic layer by peeling off the alignment film as well.

In the liquid crystal diffraction element of the present disclosure, the alignment film is provided as a preferable aspect and is not an essential configuration requirement. For example, the optically anisotropic layer can also be configured to have the liquid crystal alignment pattern in which the directions of the optical axes derived from the liquid crystal compounds change while continuously rotating along at least one direction in plane, by forming the alignment pattern on the support using a method of performing rubbing treatment on the support or a method of processing the support with laser light or the like.

The liquid crystal diffraction element 12 has regions having different single periods Λ of the liquid crystal alignment pattern and has a configuration in which the twist angle in the thickness direction is larger as the single period Λ of the liquid crystal alignment pattern is shorter. However, in the liquid crystal diffraction element of the present disclosure, conversely, the twist angle in the thickness direction may be smaller as the single period Λ of the liquid crystal alignment pattern is shorter. The twist angle in the thickness direction may be appropriately set in accordance with the single period Λ of the liquid crystal alignment pattern in plane.

The liquid crystal diffraction element 14 has a configuration in which the single period A of the liquid crystal alignment pattern is gradually shortened in the outward direction from the center of the optically anisotropic layer 34. However, in the liquid crystal diffraction element of the present disclosure, conversely, the single period Λ of the liquid crystal alignment pattern may be configured to be gradually increased in the outward direction from the center of the optically anisotropic layer 34. Furthermore, for example, as in a case of causing the transmitted ray to have a light quantity distribution, depending on a purpose of the liquid crystal diffraction element, a configuration of partially providing regions having different single periods A in the one direction in which the optical axes continuously rotate can also be used instead of gradually changing the single period Λ in the one direction in which the optical axes continuously rotate.

While the liquid crystal diffraction element is configured to include one optically anisotropic layer in the above example, the present disclosure is not limited to this, and the liquid crystal diffraction element may include two or more optically anisotropic layers. In a case where the liquid crystal diffraction element includes two or more optically anisotropic layers, the liquid crystal diffraction element may include an optically anisotropic layer having a uniform single period Λ as a whole and an optically anisotropic layer having regions having different single periods Λ. In a case where the liquid crystal diffraction element includes two or more optically anisotropic layers, the liquid crystal diffraction element may further include optically anisotropic layers having different directions of the twisted rotation (directions of the twist angle) in the thickness direction. By further including the optically anisotropic layers having different directions of the twisted rotation in the thickness direction, the transmitted ray can be efficiently refracted with respect to the incidence ray of various polarization states in the region having the twist angle in the thickness direction.

Production methods, materials, and the like of the optically anisotropic layer, the alignment film, and the support of the present disclosure are not limited to the above description and can use well-known technologies. For example, the technology according to JP6985501B can be used.

Next, an apparatus comprising the finder optical system 5 according to the embodiment of the present disclosure will be described. FIG. 25 is a schematic configuration diagram of a camera 100 that is an imaging apparatus according to one embodiment of the present disclosure. For example, the camera 100 is a digital camera.

The camera 100 comprises a finder device 101 according to one embodiment of the present disclosure. The camera 100 also comprises an imaging lens 102, an imaging element 103, a processor 104, a display unit 105, an operator 106, and a recording unit 107.

The finder device 101 comprises the finder optical system 5 according to one embodiment of the present disclosure and a driving unit 7. The finder optical system 5 includes the display element 1 and the ocular optical system 3. The driving unit 7 drives the display element 1. The display element 1 outputs output light that is polarized light. For example, the output light in the example in FIG. 25 is circularly polarized light Pc. The output light from the display element 1 is incident on the ocular optical system 3. As described above, the ocular optical system 3 includes the liquid crystal diffraction element and can efficiently guide the light from the display element 1 by converting the light incident on the ocular optical system 3 into the circularly polarized light Pc.

The output light from the display element 1 may be linearly polarized light. In this case, the circularly polarized light Pc is preferably configured to be incident on the ocular optical system 3 by disposing an element such as a ¼ waveplate between the display element 1 and the ocular optical system 3. In a case where the liquid crystal display element or an organic electroluminescence (EL) display element that outputs circularly polarized light is used as the display element 1, the output light is polarized light. Thus, the display element 1 can be configured to have good affinity with the ocular optical system 3 including the liquid crystal diffraction element.

The imaging lens 102 forms an image of a subject. The imaging element 103 captures the image formed by the imaging lens 102. For example, a charge coupled device (CCD) or a complementary metal oxide semiconductor (CMOS) can be used as the imaging element 103. The imaging element 103 outputs a captured image that is an image of the captured image to the processor 104. The processor 104 performs image processing on the captured image and outputs image data on which the image processing is performed to the display unit 105 and the driving unit 7. The display unit 105 displays the image. The driving unit 7 causes the display element 1 to display the image.

A user 110 looks through the finder device 101 and observes the image displayed on the display element 1 through the ocular optical system 3. The user 110 captures a static image or a video by operating the operator 106, and the image data obtained by this capturing is recorded in the recording unit 107.

While the disclosed technology has been described above using the embodiment and the examples, the disclosed technology is not limited to the embodiment and the examples and can be subjected to various modifications. For example, the curvature radius, the surface spacing, the refractive index, the Abbe number, the aspherical coefficient, and the phase difference coefficient of each lens are not limited to the values illustrated in each of the above numerical value examples and may have other values.

The imaging apparatus according to the embodiment of the present disclosure is not limited to the above example, and the present disclosure is also applicable to a film camera, a video camera, and the like.

The following appendices are further disclosed with respect to the embodiment and the examples described above.

### Appendix 1

A finder optical system comprising a display element, and an ocular optical system disposed on an eyepoint side with respect to the display element, in which one or more diffraction elements are disposed in the finder optical system, at least one of the diffraction elements is a first diffraction element including a liquid crystal diffraction element, and in a case where a distance on an optical axis from a display surface of the display element to a surface of the finder optical system closest to the eyepoint side is denoted by TL, and a distance on the optical axis from the display surface to an optical surface of the first diffraction element is denoted by X1, Conditional Expression (1) is satisfied, which is represented by

0.05≤X1/TL≤1 (1).

### Appendix 2

The finder optical system according to Appendix 1, in which, in a case where a half value of a longest diameter of a display region in the display element is denoted by H, and a focal length of the finder optical system is denoted by f, Conditional Expression (2) is satisfied, which is represented by

0.3<H/f<0.7 (2).

### Appendix 3

The finder optical system according to Appendix 1 or 2, in which, in a case where a distance on the optical axis from the surface of the finder optical system closest to the eyepoint side to an eyepoint is denoted by dEP, and a focal length of the finder optical system is denoted by f, Conditional Expression (3) is satisfied, which is represented by

0<f/dEP<0.95 (3).

### Appendix 4

The finder optical system according to any one of Appendices 1 to 3, in which the ocular optical system includes two or more positive lenses and one or more negative lenses.

### Appendix 5

The finder optical system according to any one of Appendices 1 to 4, in which the ocular optical system includes two or more aspherical lenses and one or more spherical lenses.

### Appendix 6

The finder optical system according to any one of Appendices 1 to 5, in which the diffraction element is provided on a surface of an optical element, and an Abbe number based on a d line for the optical element is greater than or equal to 35.

### Appendix 7

The finder optical system according to any one of Appendices 1 to 6, in which the diffraction element is provided on a surface of an optical element, and transmittance on a d line for the optical element is greater than or equal to 98%.

### Appendix 8

The finder optical system according to any one of Appendices 1 to 7, in which, in a case where a distance on the optical axis from the display surface to an optical element in the finder optical system is denoted by X, transmittance on a d line for a partial optical system consisting of all optical elements disposed within a range of 0.05≤X/TL≤1 is greater than or equal to 92%.

### Appendix 9

The finder optical system according to any one of Appendices 1 to 8, in which the diffraction element is provided on a surface of an optical element, and lenses having a refractive power are disposed on both of an object side and an image side of the optical element.

### Appendix 10

The finder optical system according to any one of Appendices 1 to 9, in which the diffraction element is provided on a surface of an optical element, a lens having a refractive power is disposed adjacent to the optical element on at least one of an object side or an image side of the optical element, and a minimum spacing in an optical axis direction between an optical surface of the diffraction element provided on the surface of the optical element and an optical surface of the lens is less than or equal to 1.8 mm.

### Appendix 11

The finder optical system according to any one of Appendices 1 to 10, in which a thickness, in an optical axis direction, of a region having a diffraction action of the diffraction element is less than or equal to 10 μm.

### Appendix 12

The finder optical system according to any one of Appendices 1 to 11, in which at least one of the diffraction elements is a second diffraction element including a liquid crystal diffraction element, an element having a refractive power is not disposed between the display surface and the second diffraction element, and in a case where a distance on the optical axis from the display surface to an optical surface of the second diffraction element is denoted by X2, Conditional Expression (4) is satisfied, which is represented by

0≤X2/TL<0.05 (4).

### Appendix 13

The finder optical system according to Appendix 12, in which a sign of a phase difference function of the first diffraction element is different from a sign of a phase difference function of the second diffraction element.

### Appendix 14

The finder optical system according to any one of Appendices 1 to 13, in which the diffraction element has a periodic structure in a direction perpendicular to the optical axis and has a concentric structure centered on the optical axis.

### Appendix 15

The finder optical system according to Appendix 14, in which a period of the periodic structure is gradually decreased from the optical axis to an edge part.

### Appendix 16

The finder optical system according to Appendix 14 to 15, in which a period of the periodic structure in a most edge part of the diffraction element is greater than or equal to 0.5 m.

### Appendix 17

The finder optical system according to any one of Appendices 1 to 16, in which the number of lenses having a refractive power included in the finder optical system is four or five.

### Appendix 18

A finder device comprising the finder optical system according to any one of Appendices 1 to 17, in which output light from the display element is polarized light.

### Appendix 19

An imaging apparatus comprising the finder optical system according to any one of Appendices 1 to 17, in which output light from the display element is polarized light.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. A finder optical system comprising:
a display element; and
an ocular optical system disposed on an eyepoint side with respect to the display element,
wherein one or more diffraction elements are disposed in the finder optical system,
at least one of the diffraction elements is a first diffraction element including a liquid crystal diffraction element,
at least one of the diffraction elements is a second diffraction element including a liquid crystal diffraction element,
an element having a refractive power is not disposed between a display surface of the display element and the second diffraction element, and
in a case where a distance on an optical axis from the display surface to a surface of the finder optical system closest to the eyepoint side is denoted by TL,
a distance on the optical axis from the display surface to an optical surface of the first diffraction element is denoted by X1, and
a distance on the optical axis from the display surface to an optical surface of the second diffraction element is denoted by X2,
Conditional Expressions (1) and (4) are satisfied, which are represented by
0.05≤X1/TL≤1 (1), and
0≤X2/TL<0.05 (4).

2. The finder optical system according to claim 1,
wherein, in a case where a half value of a longest diameter of a display region in the display element is denoted by H, and
a focal length of the finder optical system is denoted by f,
Conditional Expression (2) is satisfied, which is represented by
0.3<H/f<0.7 (2).

3. The finder optical system according to claim 1,
wherein, in a case where a distance on the optical axis from the surface of the finder optical system closest to the eyepoint side to an eyepoint is denoted by dEP, and
a focal length of the finder optical system is denoted by f,
Conditional Expression (3) is satisfied, which is represented by
0<f/dEP<0.95 (3).

4. The finder optical system according to claim 1,
wherein the ocular optical system includes two or more positive lenses and one or more negative lenses.

5. The finder optical system according to claim 1,
wherein the ocular optical system includes two or more aspherical lenses and one or more spherical lenses.

6. The finder optical system according to claim 1,
wherein the diffraction element is provided on a surface of an optical element, and
an Abbe number based on a d line for the optical element is greater than or equal to 35.

7. The finder optical system according to claim 1,
wherein the diffraction element is provided on a surface of an optical element, and
transmittance on a d line for the optical element is greater than or equal to 98%.

8. The finder optical system according to claim 1,
wherein, in a case where a distance on the optical axis from the display surface to an optical element in the finder optical system is denoted by X, transmittance on a d line for a partial optical system consisting of all optical elements disposed within a range of 0.05≤X/TL≤1 is greater than or equal to 92%.

9. The finder optical system according to claim 1,
wherein the diffraction element is provided on a surface of an optical element, and
lenses having a refractive power are disposed on both of an object side and an image side of the optical element.

10. The finder optical system according to claim 1,
wherein the diffraction element is provided on a surface of an optical element,
a lens having a refractive power is disposed adjacent to the optical element on at least one of an object side or an image side of the optical element, and
a minimum spacing in an optical axis direction between an optical surface of the diffraction element provided on the surface of the optical element and an optical surface of the lens is less than or equal to 1.8 mm.

11. The finder optical system according to claim 1,
wherein a thickness, in an optical axis direction, of a region having a diffraction action of the diffraction element is less than or equal to 10 μm.

12. The finder optical system according to claim 1,
wherein a sign of a phase difference function of the first diffraction element is different from a sign of a phase difference function of the second diffraction element.

13. The finder optical system according to claim 1,
wherein the diffraction element has a periodic structure in a direction perpendicular to the optical axis and has a concentric structure centered on the optical axis.

14. The finder optical system according to claim 13,
wherein a period of the periodic structure is gradually decreased from the optical axis to an edge part.

15. The finder optical system according to claim 13,
wherein a period of the periodic structure in a most edge part of the diffraction element is greater than or equal to 0.5 μm.

16. The finder optical system according to claim 1,
wherein the number of lenses having a refractive power included in the finder optical system is four or five.

17. A finder device comprising:
the finder optical system according to claim 1,
wherein output light from the display element is polarized light.

18. An imaging apparatus comprising:
the finder optical system according to claim 1,
wherein output light from the display element is polarized light.
